(19) United States
(12) Patent Application Publication
(10) Pub. No.: US 2010/0277047 A1
(43) Pub. Date: Nov. 4, 2010

(54) Hand free releasing lock for drawer structure

(76) Inventor: Henry Chen Sung, San Marcos, CA (US)

Correspondence Address: DAVID AND RAYMOND PATENT FIRM, 108 N. YNEZ AVE., SUITE 128, MONTEREY PARK, CA, 91754, US

(21) Appl. No.: 12/798,903

(22) Filed: Apr. 12, 2010

Related U.S. Application Data
(63) Continuation-in-part of application No. 12/387,110, filed on Apr. 27, 2009.

(51) Int. Cl. A47B 88/12; E05B 65/46

(52) U.S. Cl. 312/333

(57) ABSTRACT

A drawer releasing device includes a docking frame and an actuation unit. The docking frame include a mounting base and a slider platform inclinedly and slidably engaging therewith to move between a slide-in storage position to dispose the slider platform within a drawer compartment of a cabinet and a slide-out accessing position to slide the slider platform out of the drawer compartment. The actuation unit includes a locking unit to retain the slider platform at the storage position by locking up with the mounting base, and a hand-free actuation unit for actuating the locking unit to unlock the engagement between the slider platform and the mounting base at the accessing position. The hand-free actuator is located out of the drawer compartment, so that the user is able to actuate the locking unit to automatically slide out the slider platform at a distance.

### CROSS REFERENCE OF RELATED APPLICATION

This is a Continuation-In-Part application that claims the benefit of priority under 35U.S.C.§119 to a non-provisional application, application Ser. No. 12/387,110, filed Apr. 27, 2009.

### BACKGROUND OF THE PRESENT INVENTION

1. Field of Invention

The present invention relates to a drawer, and more particularly to a hand free drawer releasing device which is capable of releasing a drawer structure through simple actuation at a distance therefrom.

2. Description of Related Arts

A conventional drawer usually comprises a drawer body and a front panel, wherein the drawer body is slidably mounted on a drawer compartment formed on a cabinet so that a user is able to slide the drawer body in and out of the drawer compartment for achieving different purposes.

Drawers have widely been utilized in a wide variety of circumstances and a number of accessories have been incorporated into conventional drawers in order to fit new situations in which a drawer may be utilized. For example, power unit has been incorporated into conventional drawer so that the user does not need to manually open or close the drawer.

Despite their long and widespread applications, there exist several deep-seated disadvantages which need to be addressed. First, the most usual way of opening a drawer is by the user's hand. From the view point of many, this may seem inevitable because one nevertheless has to manually open a drawer in order to retrieve or put in something. Yet there exist situations where it is not desirable or convenient for the user's hand to touch the drawer's handle for opening it. For example, when the user is in the middle of doing something in which his/her hands are contacting with, say, dirty materials or raw food (if the drawer in a kitchen), the user may not wish to let his/her hands touching the drawer's handle for opening the drawer, even though in fact the user actually needs to open the drawer for retrieving something which he/she needs at that moment.

Second, if a drawer is fully loaded so that a considerable amount of force is required to pull the drawer out of the drawer compartment, the user may not have enough power to do so. This problem may not be that severe for drawers used in domestic environment, yet in workplaces such as in the office, a particular cabinet may contain a huge amount of files so that the user may not be able to pull the particular drawers out of the corresponding drawer compartments for retrieving, say, particular files.

If the drawer is positioned at a very low position, such as the lowest in a cabinet, it is difficult then for a user to effectively exert large amount of force for pulling the drawer out of the drawer compartment.

Obviously, one may purchase motorized drawers for resolving the above problems, but the main problem is that motorized drawers are usually expensive and as a result may not be affordable for general households. Moreover, even though one may afford to purchase sophisticated drawers, the first problem is still not yet resolved since the relevant users still have to use their hands for operating any control panels or even remote controllers.

### SUMMARY OF THE PRESENT INVENTION

The invention is advantageous in that it provides a drawer releasing device for a drawer, wherein the drawer releasing device is capable of releasing the drawer through simple actuation at a distance therefrom in a hand-free manner. In other words, a user of the present invention does not need to physically touch the drawer for pulling it out.

Another advantage of the invention is to a drawer releasing device, which is capable of automatically releasing a drawer out of the drawer compartment upon a simple actuation of an actuation unit extended out of the drawer by the user of the present invention. In other words, when the drawer is fully loaded, the user does not need to exert large amount of force for trying to pull put the drawer from the drawer compartment.

Another advantage of the invention is to a drawer releasing device, wherein an initial momentum of the slider platform drives the drawer for automatically sliding out of the drawer compartment in a hand-free manner, so as to prevent the drawer from being stuck in the drawer compartment by means of its own weight.

Another advantage of the invention is to a drawer releasing device, which comprises a double-braking configuration for decelerating the drawer being slid from the slide-in storage position to the slide-out accessing position for safety purpose.

Another advantage of the invention is to a drawer releasing device, which can substantially reduce the noise being generated during the impact when the drawer is slid out of the drawer compartment.

Another advantage of the invention is to a drawer releasing device, wherein the drawer can be securely retained within the drawer compartment by means of magnetic attractive force at a rear side of the slider platform. In addition, the releasing operation of the magnetic attractive force is relatively simple and easy to enhance the lock-and-unlock structural configuration of the locking unit incorporating with the slider platform.

Another advantage of the invention is to provide a drawer releasing device which is adjustable in its orientation and easy to assemble and disassemble so as to fit a wide variety of drawer compartment in order to facilitate widespread application of the present invention.

Another advantage of the invention is to provide a drawer releasing device which can be adopted to use in conjunction with a wide variety of containers for fitting a wide variety of different circumstances. For example, a slider platform may be adapted to support rubbish bins or a basket for normally receiving the rubbish bin or the basket into a drawer compartment while automatically releasing the rubbish bin to be extended for convenient access by the user of the present invention.

Another advantage of the invention is to provide a drawer releasing device which does not involve electrical components and even complicated mechanical component, so that the manufacturing cost and the ultimate selling price of the present invention can be kept to minimum.

Additional advantages and features of the invention will become apparent from the description which follows, and may be realized by means of the instrumentalities and combinations particular point out in the appended claims.

According to the present invention, the foregoing and other objects and advantages are attained by a drawer releasing device which comprises a docking frame and an actuation unit

The docking frame, which is adapted for supporting within the drawer compartment of the drawer, comprises a mounting base and a slider platform. The mounting base comprises two spaced apart sliding tracks extending in an inclined manner that a rear end of each of the sliding tracks is positioned higher than a front end of the sliding track. The slider platform comprises two spaced apart longitudinal members slidably coupled with the sliding tracks respectively to inclinedly support the slider platform on the mounting base in a stably slidable manner, wherein the slider platform is adapted to slide between a slide-in storage position that the slider platform is disposed within the drawer compartment and a slide-out accessing position that the slider platform is slid out of the drawer compartment.

The actuation unit comprises a hand-free actuator positioned out of the drawer compartment and a locking unit which is operatively linked to the hand-free actuator and is mounted on the mounting base to releasably engage with the slider platform to lock up the slider platform at the storage position, wherein when the hand-free actuator is actuated, the locking unit is unlocked to release the slider platform with respect to the mounting base, an initial momentum of the slider platform drives the slider platform for automatically sliding out of the drawer compartment in a hand-free manner.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a drawer releasing device for a drawer according to a first preferred embodiment of the present invention.

FIG. 2 is an exploded perspective view of the drawer releasing device according to the above first preferred embodiment of the present invention.

FIG. 3 is a schematic diagram of the drawer releasing device according to the above first preferred embodiment of the present invention.

FIG. 4 is a schematic diagram of the drawer releasing device according to the above first preferred embodiment of the present invention illustrating that the slider platform is in the storage position.

FIG. 5 is a schematic diagram of the drawer releasing device according to the above first preferred embodiment of the present invention, illustrating that the slider platform is in the accessing position.

FIG. 6 is a perspective view of the drawer releasing device according to the above first preferred embodiment of the present invention, illustrating that the inclination adjuster is formed in the mounting base.

FIG. 7 is a perspective view of a drawer releasing device according to a second preferred embodiment of the present invention.

FIG. 8 is a first schematic diagram of the drawer releasing device according to the above second preferred embodiment of the present invention.

FIG. 9 is a second schematic diagram of the drawer releasing device according to the above second preferred embodiment of the present invention.

FIG. 10 is a perspective view of a drawer releasing device according to a third preferred embodiment of the present invention.

FIG. 11A and FIG. 11B are schematic diagrams of the drawer releasing device according to the above third preferred embodiment of the present invention.

FIG. 12 is an alternative mode of the drawer releasing device according to the above third preferred embodiment of the present invention.

FIG. 13 is a schematic diagram of the alternative mode of the drawer releasing device according to the above third preferred embodiment of the present invention.

FIG. 14 is a perspective view of a drawer releasing device according to a fourth preferred embodiment of the present invention.

FIG. 15 is a cross sectional view of the drawing releasing device according to the above fourth preferred embodiment of the present invention.

FIG. 16 is a side view of the drawing releasing device according to the above fourth preferred embodiment of the present invention.

FIG. 17 is a rear view of the drawing releasing device according to the above fourth preferred embodiment of the present invention, illustrating the actuator aligning with the engaging member in the storage position.

FIG. 18 is another rear view of the drawing releasing device according to the above fourth preferred embodiment of the present invention, illustrating the actuator misaligning with the engaging member in the accessing position.

FIG. 19 is a partially top view of the drawing releasing device according to the above fourth preferred embodiment of the present invention, illustrating a braking system of the drawing releasing device.

FIG. 20 is a top perspective of the drawing releasing device according to the above fourth preferred embodiment of the present invention.

FIG. 21 is a partial side sectional view of the drawing releasing device according to the above fourth preferred embodiment of the present invention, illustrating the front panel support adjustably mounted at slider platform.

### DETAILED DESCRIPTION OF THE PREFERRED EMBODIMENT

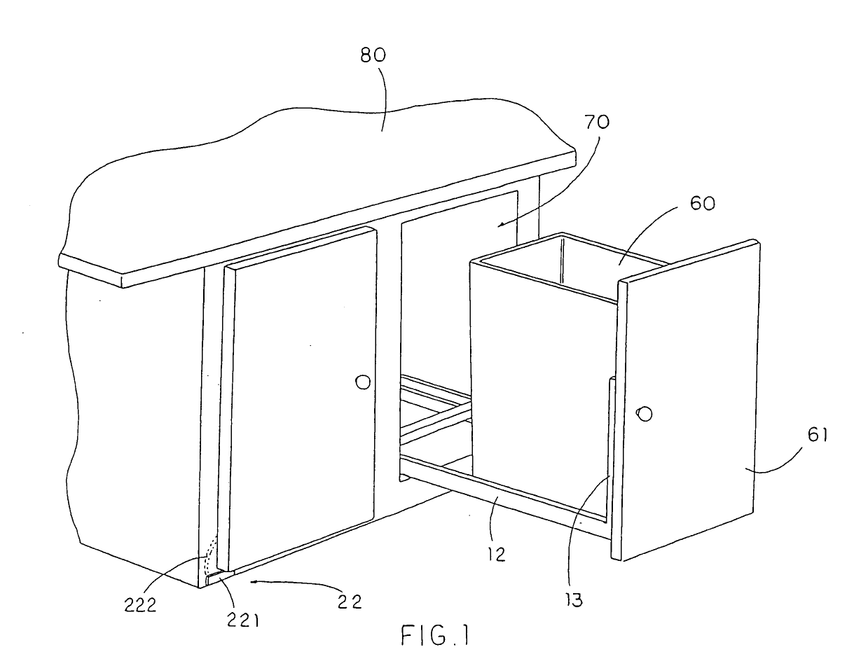

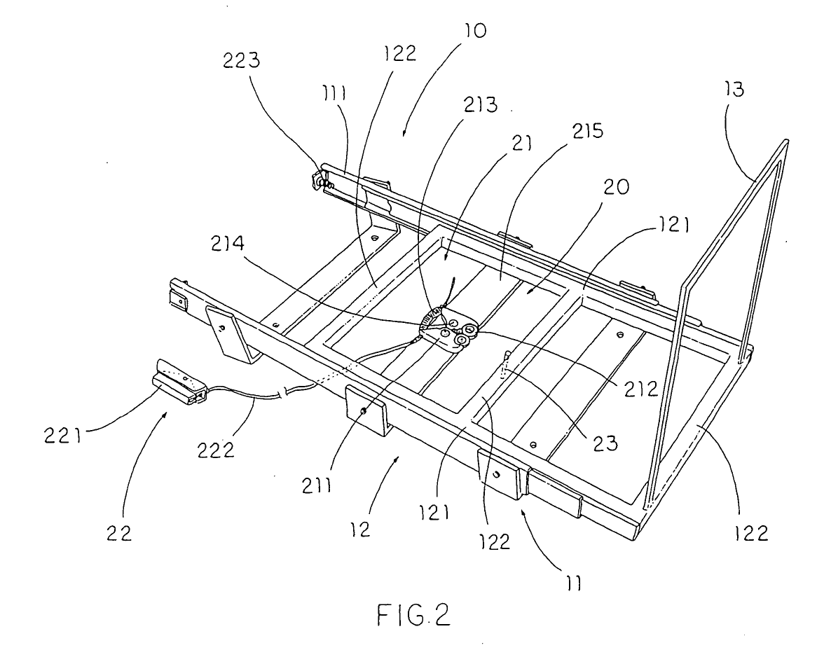

Referring to FIG. 1 to FIG. 2 of the drawings, a drawer releasing device for a cabinet 80 according to a preferred embodiment of the present invention is illustrated, in which the drawer releasing device comprises a docking frame 10 and a locking arrangement 20. The cabinet 80, such as a conventional cabinet, has at least one drawer compartment 70 formed between two sidewalls, wherein the drawer releasing device is preferably to be fittedly received in the drawer compartment 70 for releasably receiving a drawer 60 therein.

Thus, the docking frame 10 is adapted for supporting within the drawer compartment 70 of the cabinet 80, and comprises a mounting base 11 and a slider platform 12 slidably and inclinedly mounted on the mounting base 11 to slide between a slide-in storage position that the slider platform 12 is disposed within the drawer compartment 70, and a slide-out accessing position that the slider platform 12 is slid out of the drawer compartment 70.

On the other hand, the locking arrangement 20 comprises a locking unit 21 and an actuation unit 22, in which the locking unit 21 is substantially mounted on the mounting base 11 to releasably engage with the slider platform 12 to lock up the slider platform 12 at said storage position.

The actuation unit 22 comprises an actuator 221 positioned out of the drawer compartment 70 and an actuating cable 222 which is extended from the locking unit 21 to the actuator 221 and is arranged in such a manner that when the actuator 221 is operated to release an engagement of the locking unit through the actuating cable 222, the slider platform 12 is automatically sliding out of the drawer compartment 70 in a hand-free manner.

According to the preferred embodiment of the present invention, the mounting base 11 comprises a pair of sliding tracks 111 alignedly mounted on an inner side of the sidewalls of the drawer compartment 70 wherein the slider platform 12 is slidably and inclinedly mounted with the sliding tracks 111 for sliding between the storage position and the accessing position alone the two sliding tracks 111 in a speed controlling manner. As a result, each of the sliding tracks 111 comprises a plurality of rolling balls 1111 rotatably provided therein for facilitating a sliding motion of the slider platform 12 with respect to the sliding tracks 111 in a speed controlled manner. In other words, the rolling balls 1111 allows controlling the speed of sliding movement of the slider platform 12 by the friction at the rolling balls 1111 within the respective sliding tracks 111.

The slider platform 12 is preferably embodied as having a quadrilateral cross section having a pair of elongated longitudinal members 121 slidably mounted with the sliding tracks 111 respectively, and three transverse members 122 transversely and spacedly extended across the two longitudinal members 121 for securely supporting the drawer 60 on the slider platform 12. For the sake of convenience, the three transverse members 122 is categorized as a front and a rear transverse members 122 extended across the two corresponding end portions of the longitudinal members 121 respectively, and a middle transverse member 122 extended across two corresponding mid portions of the longitudinal members 121 respectively.

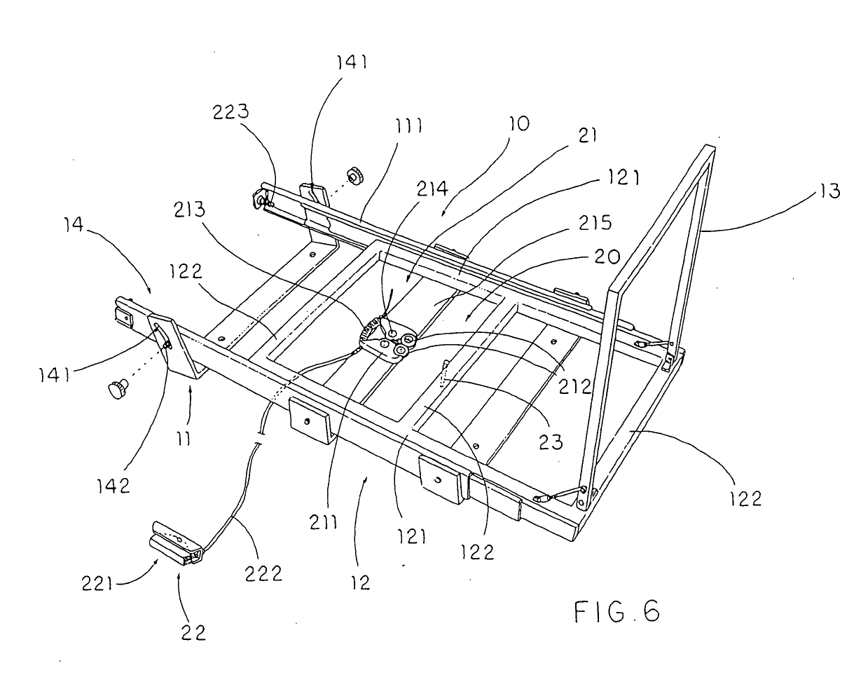

Referring to FIG. 1, FIG. 2, and FIG. 6 of the drawings, the docking frame 10 further comprises a drawer panel support 13 upwardly extended from the front transverse member 122 (a front edge) of the slider platform 12, wherein a front panel 60 of the drawer 60 is arranged to be mounted on the front transverse member 122 so as to cover the drawer compartment 70 when the slider platform 12 is slid into the storage position.

In order to maximize the suitability of the drawer releasing device of the present invention with different kinds of cabinets 80 having different geographical structures, the drawer panel support 13 can adjustably and pivotally be mounted with the front transverse member 122 so that the front panel 61 is capable of being mounted in a wide variety of orientations for fitting with different geographical structures of the cabinet 80 (FIG. 6). Thus, the front panel 61 can be able to be selectively adjusted in a vertical orientation to fittingly enclose the drawer compartment 60 when the slider platform 12 is slid thereinto at the storage position.

Referring to FIG. 1 to FIG. 3 of the drawings, the locking unit 21 comprises two locking arms 211, which are pivotally connected to the mounting base 10, having two driving ends 2111 engaging with the actuating cable 222 and two engaging ends 2112 to securely clip to the slider platform 12 to retain the slider platform 12 at the storage position and arranged in such a manner that when the actuating cable 222 is slid to move the driving ends 2111 of the locking arms 211 towards each other, the engaging ends 2112 thereof are pivotally moved to release the slider platform 12 from the locking arms 211 so as to unlock the slider platform 12 for freely sliding out of the drawer compartment 70.

Moreover, the locking unit 21 further comprises two locking rotors 212 rotatably mounted at the engaging ends 2112 of the locking arms 211 respectively to engage with the slider platform 12 for allowing the slider platform 12 being manually slid out from the drawer compartment 70 when a pulling force is applied on the slider platform 12.

It is worth mentioning that the driving end 2111 of one of the locking arms 211 is affixed to the actuating cable 222 while the driving end 2111 of another of the locking arm 211 is slidably mounted to the actuating cable 222, such that when the actuating cable 222 is pulled by the actuator 221 to move the driving ends 2111 of the locking arms 211 towards each other, the engaging ends 2112 of the locking arms 211 are moved away from each other to release the slider platform 12.

The locking unit 21 further comprises a resilient element 213 having two ends biasing against the driving ends 2111 of the locking arms 211 respectively so as to apply an urging force on the locking arms 211 to ensure the slider platform 12 being clipped by the engaging ends 2112 of the locking arms 211.

According to the preferred embodiment of the present invention, each of the locking arms 211 has gear joint 214 formed between the driving end 2111 and the engaging end 2112, wherein the gear joints 214 of the locking arms 211 are coupled with each other to control the engaging ends 2112 of the locking arms 211 engaging with the slider platform 12 in a coordinating manner.

Furthermore, the locking unit 21 further comprises a locker base 215 transversely extended on the mounting base 11 of the docking frame 10, wherein the locking arms 211 are provided on the locker base 215 for engaging with the slider platform 12 when it is slid at the storage position.

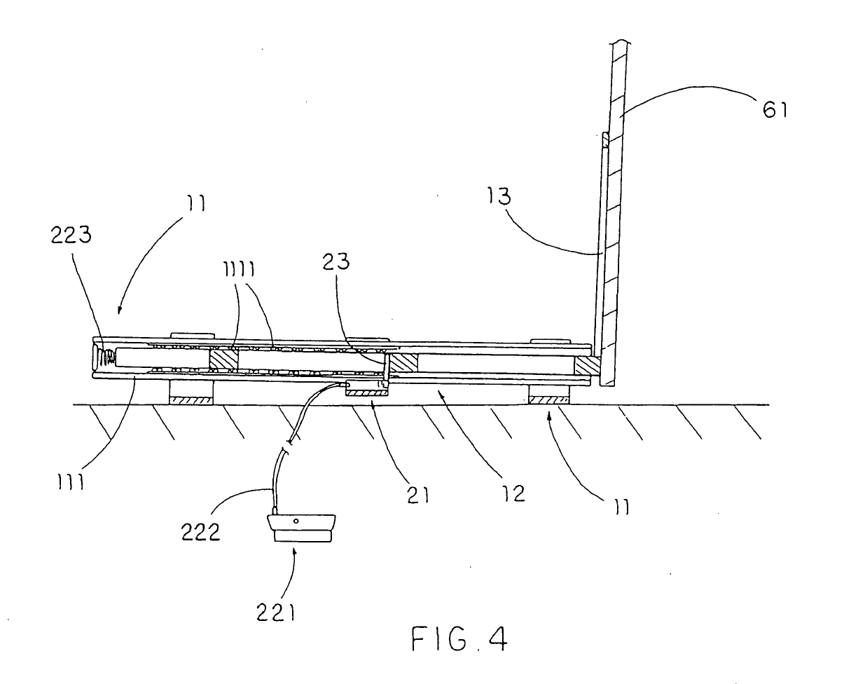

Accordingly, the locking arrangement 20 further comprises an engaging member 23 provided on one of the transverse members 122 and arranged to releasably engage with the locking arms 211 of the locking unit 21 when the slider platform 12 is slid at the storage position. In other words, the engaging member 23 is at the corresponding position with the locking arms 211 so that when the slider platform 12 is at the storage position, the engaging member 23 and the lock engaging device 212 are releasably engaged so as to normally retain the slider platform 12 at the storage position, as shown in FIG. 4 of the drawings.

In other words, the user of the present invention is able to manually pull out the slider platform 12 from the storage position to the accessing position by exerting a sufficient amount of pulling force to overcome the inward biasing force exerted by the resilient element 213 to the engaging member 23. However, it is important to realize that the biasing force exerted by the resilient element 213 is such that the slider platform 12 is normally locked up and retained at the storage position if there is no extra pulling force exerted by the user of the present invention.

On the other hand, the actuator 221 is extended out of the cabinet 80 by the actuating cable 222 so that the user of the present invention may release the engagement between the slider platform 12 and the lock engaging device 212 at a distance through operating upon the actuator 221. Therefore, the actuator 221 can be selectively located away from the docking frame 10 for operating the locking arrangement 20. More specifically, the actuating cable 222, which is preferably embodied as a metal-made wire enclosed with durable and flexible plastic materials, has a driving end portion extended away from the drawer compartment 70 and connected with the actuator 221, and a driven end portion operatively connected with locking arms 211 in such a manner that when the actuator 221 is operated, the driven end portion of the actuating cable 222 is pulled to exert an urging force towards the locking arms 211 for pivotally driving the locking arms 211 to disengage with the engagement member 23 provided on the slider platform 12 so as to release the engagement between the slider platform 12 and the mounting base 11.

According to the preferred embodiment of the present invention, the actuator 221 comprises first and second actuation members 2211, 2212 pivotally connected with each other in such a manner that the first actuation member 2211 is adapted to be depressed with respect to the second actuation member 2212, wherein the driving end of the actuating cable 222 is connected with the first actuation members 2211 so that when the first actuation members 2211 is depressed, the driving end of the actuating cable 222 is pulled for pulling the driven end thereof so as to release the engagement between the slider platform 12 and the mounting base 11.

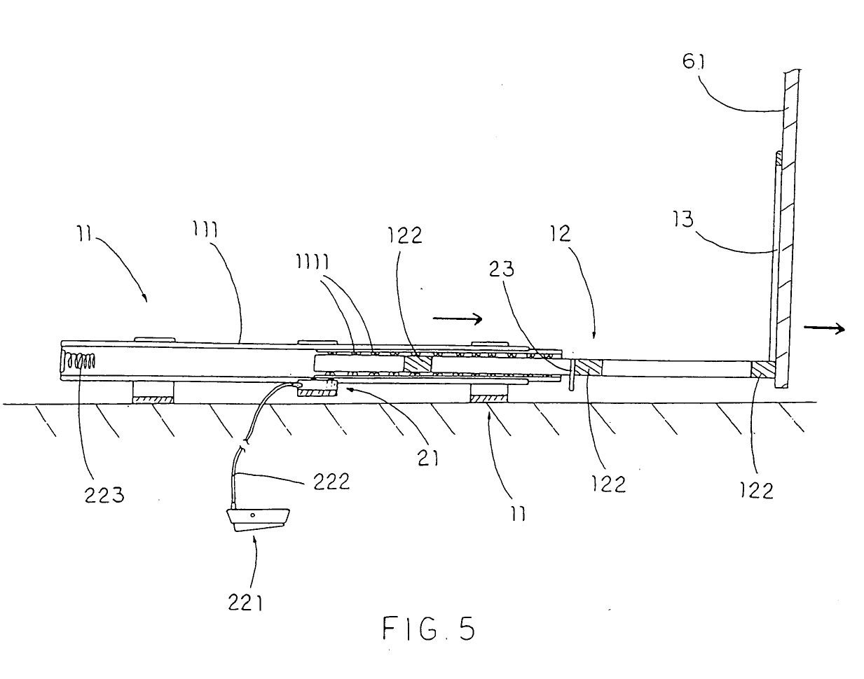

Referring to FIG. 4 to FIG. 5 of the drawings, when the engagement between the slider platform 12 and the mounting base 11 is released, since the sliding tracks 111 are downwardly inclined towards the front side of the cabinet 80, therefore, the sliding platform 12 will automatically due to natural gravitational force slide alone the sliding tracks 111 for moving from the storage position and the accessing position, as shown in FIG. 5 of the drawings.

It is worth mentioning at this point that in order to enhance the automatic sliding motion of the slider platform 12 when the engagement between the slider platform 12 and the mounting base 11 has been released, the actuation unit 22 further comprises a pair of resilient members 223 mounted at the sliding tracks 111 respectively for normally exerting an initial forward pushing force towards the slider platform 12 in such a manner that when the engagement between the slider platform 12 and the mounting base 11 is released, the resilient members 223 will push the slider platform 12 frontwardly towards the accessing position. In other words, the slider platform 12 is effectively pushed to slide from the storage position towards the accessing position in the above automatic manner.

In other words, the resilient members 223 can restore a predetermined energy, i.e. the compression spring force, when the slider platform 12 is pushed back to the storage position. Once the actuator 221 is actuated, the restored energy will release to convert into the initial forward pushing force towards the slider platform 12. Therefore, the initial forward pushing force will be restored every time when the slider platform 12 is pushed back to the storage position.

Moreover, as shown in FIG. 6 of the drawings, the sliding tracks 111 can be pivotally and adjustably mounted at the drawer compartment 70 for adjusting an angle of inclination of the docking frame 10 so as to allow the present invention to be utilized in a wide variety of circumstances. In order to further enhance universality of the present invention, the mounting base 11 may further comprise an inclination adjuster 14 which has a slider slot 141 formed on the mounting base 10 and comprises a slider member 142 which is extended from the slider platform 12 and is slidably engaged with the slider slot 141 to selectively adjust an inclination angle of the slider platform 12 with respect to the mounting base 10.

The operation and application of the present invention is as follows: the docking frame 10 is received in the drawer compartment 70 wherein the drawer or any other container, such as a rubbish bin, is supported on the slider platform 12. The actuator 221 is extended from the slider platform 12 to an exterior of the cabinet 80 so that the user is able to actuate it at a distance. It is important to emphasis that actuator 221 is preferably to be positioned on a ground surface so that the user may operate the actuator by his/her foot without using his/her hands.

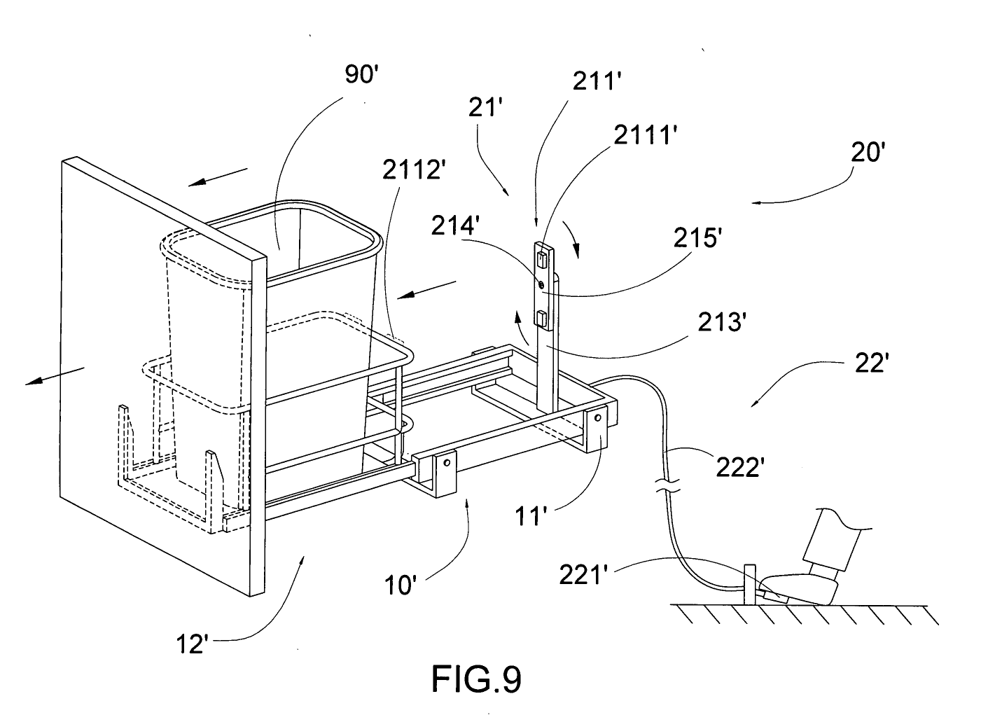

Referring to 7 to FIG. 9 of the drawings, a drawer releasing device for a cabinet 80′ having a drawer compartment 70′ according to a second preferred embodiment of the present invention is illustrated. The drawer releasing device comprises a docking frame 10′ and a locking arrangement 20′ comprising an actuation unit 22′.

The docking frame 10′, which is adapted for supporting within the drawer compartment 70′ of the cabinet 80′, comprises a mounting base 11′ and a preferably metallic slider platform 12′ slidably and inclinedly mounted on the mounting base 11′ to slide between a slide-in storage position that the slider platform 12′ is disposed within the drawer compartment 70′ and a slide-out accessing position that the slider platform 12′ is slid out of the drawer compartment 70′, wherein the mounting base 11′ is normally retained at the slide-in storage position.

The actuation unit 22′ comprises a hand-free actuator 221′ positioned out of the drawer compartment 70′ and an actuating cable 222′ which is extended from the docking frame 10′ to the actuator 221′ and is arranged in such a manner that when the actuator 221′ is operated for providing an initial momentum of the slider platform 12′, the slider platform 12′ automatically slides out of the drawer compartment 70′ in a hand-free manner.

According to the second preferred embodiment of the present invention, the locking arrangement 20′ further comprises a locking unit 21′ substantially mounted on the mounting base 11′ to releasably engage with the slider platform 12′ to lock up the slider platform 12′ at the storage position, wherein the locking unit 21′ comprises at least one magnetic member 211′ arranged to normally exert a magnetic attractive force toward the docking frame 10′ so as to normally retain the slider platform 12′ at the storage position. In this first alternative mode, a container 90′ is supported by the slider platform 12′ so that when the slider platform 12′ slides out of the drawer compartment 70′, the container 90′ is driven to slide out of the drawer compartment 70′. The actuator 221′ is operated to release the engagement of the locking unit 21′ through the actuating cable 222′. In other words, the magnetic member 211′ is provided at the mounting base 11′ for exerting magnetic attractive force towards the slider platform 12′ so as to normally retain the slider platform 12′ at the storage position.

The locking unit 21′ further comprises a retention member 212′ extended to align with the container 90′ and the slider platform 12′ wherein the magnetic member 211′ is spacedly provided on the retention member 212′ for magnetically retaining the slider platform 12′ and the container 90′ at the storage position. The locking unit 21′ further comprises a connecting member 213′ extended from the mounting base 11′ of the docking frame 10′ to rotatably connect with the retention member 212′, in such a manner that the retention member 212′ is capable of pivotally rotating about a rotation pivot 214′ mounted on the connecting member 213′. Preferably, the magnetic member 211′ is embodied as a magnetic element provided on the retention member 212′, wherein when the slider platform 12′ is in the normal storage position, the magnetic member 211′ is arranged to magnetically attract the slider platform 12′ on the mounting base 11′ so as to retain the container 90′ within the drawer compartment 70′. In other words, when the magnetic engagement between the slider platform 12′ and the retention member 212′ ceases to exist, the slider platform 12′ is arranged to slide out of the drawer compartment 70′ so as to be accessed by the user of the present invention. Since the slider platform 12′ is inclinedly mounted with respective to horizontal, when the magnetic attractive force ceases to exist, the slider platform 12′, owning to its own weight, will slide out of the drawer compartment 70′ due to normal gravitational force. The actuating cable 222′ is extended to couple with the retention member 212′ and is arranged to pivotally move the retention member 212′ when the actuator 221′ is operated for releasing a magnetic engagement between the mounting base 11′ and the slider platform 12′.

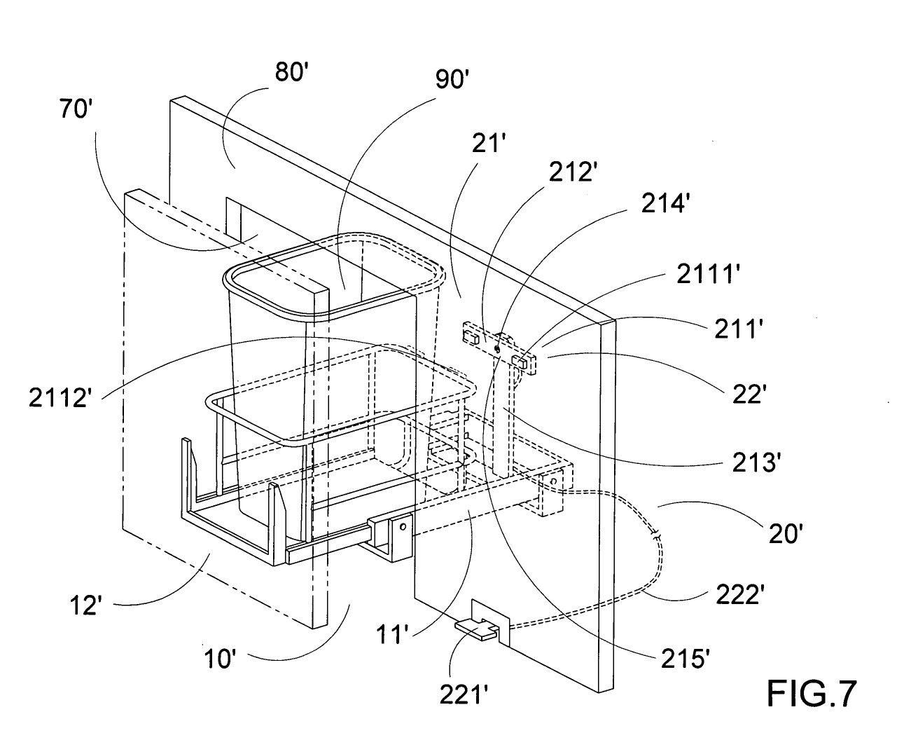

The magnetic member 211′ can comprise two or more magnetic elements 2111′ spacedly provided at the retention member 212′, wherein the slider platform 12′ is made of magnetic attractive material (such as metal) such that the magnets are magnetically locked up with the slider platform 12′ at the storage position. Alternatively, the magnetic member 211′ can also comprise two or more first magnetic elements 2111′ spacedly provided at the retention member 212′ and two or more second magnetic elements 2112′ (FIG. 7 and FIG. 9) spacedly provided at the slider platform 12′ to align with the first magnetic elements 2111′ respectively such that the slider platform 12′ is magnetically locked at the storage position when the second magnetic elements 2112′ are magnetically engaged with the first magnetic elements 2111′ respectively.

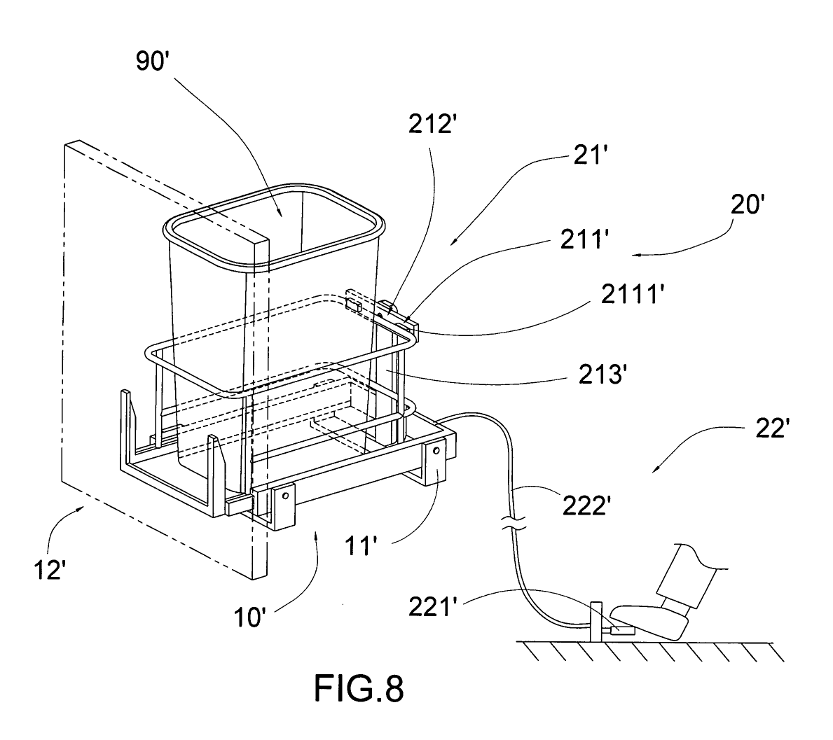

As shown in FIG. 7 to FIG. 9 of the drawings, the connecting member 213′ is pivotally coupled with a mid-portion of the retention member 212′ to form a T-shape structure, wherein the actuating cable 222′, which is embodied as a metal wire enclosed with durable and flexible plastic material, is extended to couple with an end portion of the retention member 212′ such that when the actuating cable 222′ is pulled via the actuator 221′, the retention member 212′ is pivotally moved to magnetically disengage with the slider platform 12′. Moreover, the locking unit 21′ further comprises a resilient element 215′ coupling between the connecting member 213′ and the retention member 212′ for applying an urging force against the retention member 212′ to pivotally pull back the retention member 212′ to its original position when the pulling force of the actuating cable 222′ has been released.

Where the container 90′ has a container cover 91′, the drawer releasing device further comprises a cover control 30′ for automatically controlling a pivot movement of a container cover 91′ of a container 90′ which sits on the slider platform 12′, wherein the cover control 30′ comprises a guiding track 31′ having a convex guiding surface 311′, and a height adjustable support 32′ suspendedly supported the guiding track 31′ within the drawer compartment 70′ at a position above the container cover 91′, in such a manner that when the slider platform 12′ is slid at the slide-in storage position, the guiding track 31′ is adapted for guiding the container cover 91′ at the convex guiding surface 311′ to close the container 90′, and when the slider platform 12′ is slid at the slide-out accessing position, the guiding track 31′ is adapted for guiding the container cover 91′ at the convex guiding surface 311′ to open the container 90′. The cover control 30′ may also comprise a plurality of guiding rollers 32′ rotatably provided on the guiding track 31′ for further allowing smooth opening or closing of the container cover 91′.

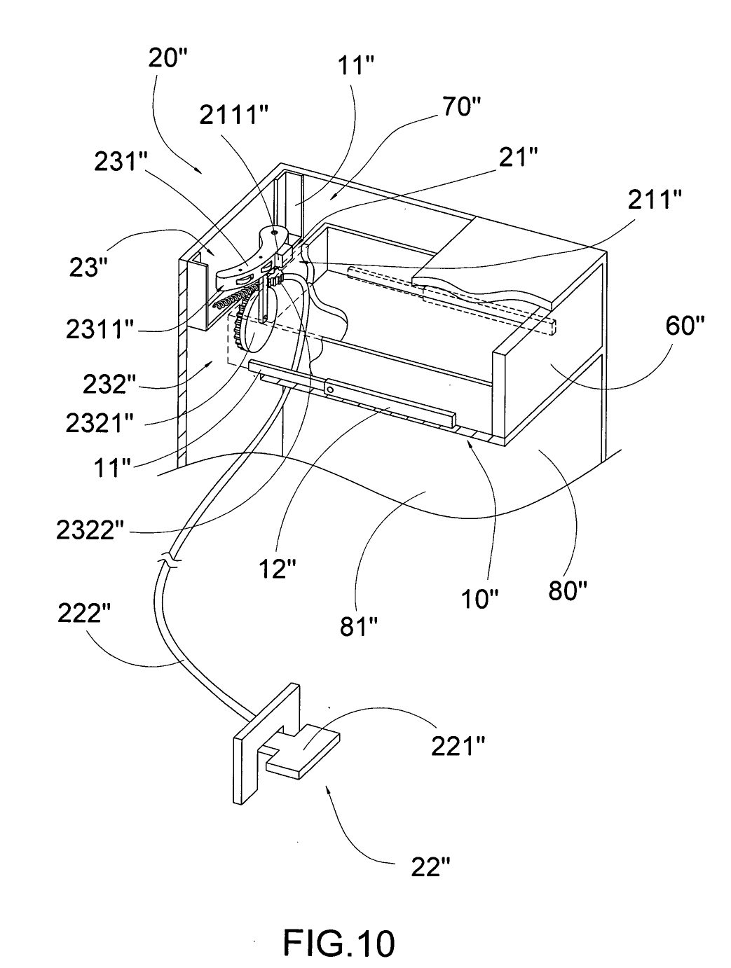

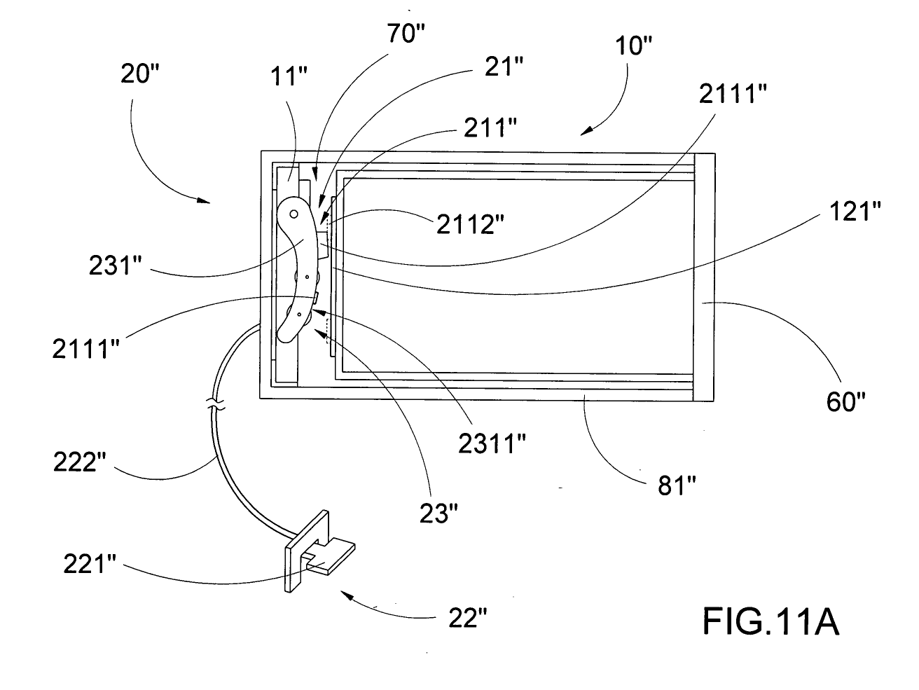

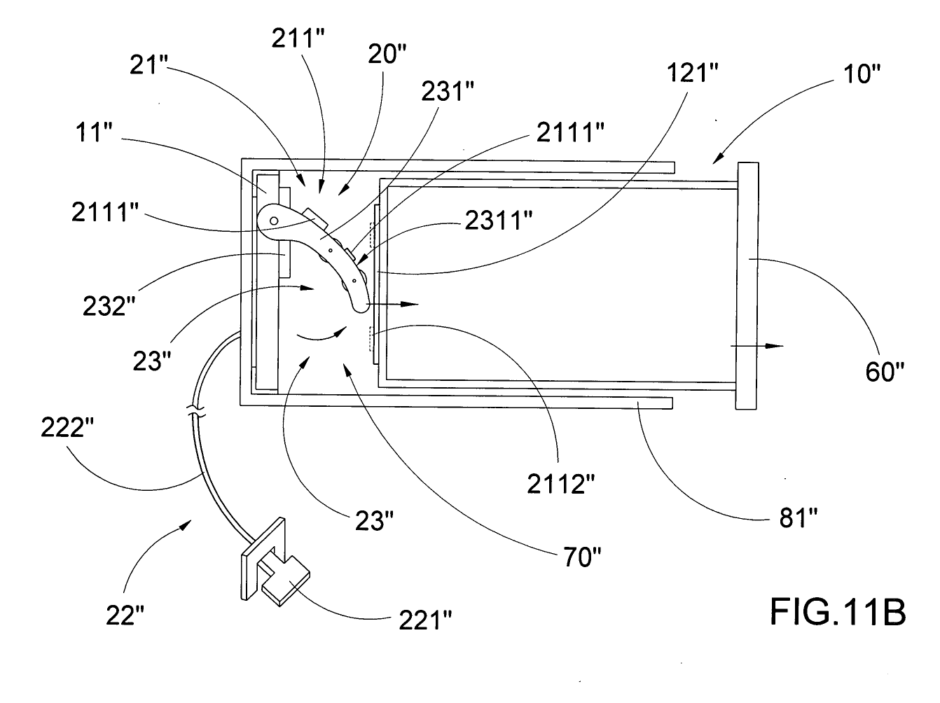

Referring to FIG. 10, FIG. 11A and FIG. 11B of the drawings, a drawer releasing device according to a third preferred embodiment of the present invention is illustrated, in which the drawer releasing device for a cabinet 80″ comprises a docking frame 10″ and a locking arrangement 20″. The cabinet 80″, such as a conventional cabinet, has at least one drawer compartment 70″ formed between two sidewalls 81″, wherein the drawer releasing device is preferably to be fittedly received in the drawer compartment 70″ for releasably receiving a drawer 60″ therein.

Thus, the docking frame 10″ is adapted for supporting within the drawer compartment 70″ of the cabinet 80″, and comprises a mounting base 11″ and a slider platform 12″ slidably and inclinedly mounted on the mounting base 11″ to slide between a slide-in storage position that the slider platform 12″ is disposed within the drawer compartment 70″, and a slide-out accessing position that the slider platform 12″ is slid out of the drawer compartment 70″.

On the other hand, the locking arrangement 20″ comprises a locking unit 21″ and an actuation unit 22″, in which the locking unit 21″ is substantially mounted on the mounting base 11″ to releasably engage with the slider platform 12″ to lock up the slider platform 12″ at the storage position, wherein the locking unit 21″ comprises at least one magnetic member 211″ arranged to normally exert a magnetic attractive force toward the docking frame 10″ so as to normally retain the slider platform 12″ at the storage position. Accordingly, the slider platform 12″ further comprises a metallic panel 121″ provided on a rear side of the drawer 60″ for aligning with the magnetic member 211″, wherein the magnetic member 211″ is arranged to magnetically attract the metallic panel 121″ for retaining the slider platform 12″ and the drawer 60″ within the drawer compartment 70″.

The actuation unit 22″ comprises an actuator 221″ positioned out of the drawer compartment 70″ and an actuating cable 222″ which is extended from the locking unit 21″ to the actuator 221″ and is arranged in such a manner that when the actuator 221″ is operated to release an engagement of the locking unit 21″ through the actuating cable 222″, the slider platform 12″ automatically slides out of the drawer compartment 70″ in a hand-free manner.

Accordingly, the locking arrangement 20″ further comprises a pusher arrangement 23″ operatively connecting the actuation unit 22″ and the locking unit 21″ in such a manner that when the actuation unit 22″ is activated to release the slider platform 12″, the pusher arrangement 23″ is arranged to initiate a pusher action towards the slider platform 12″ so as to assist smooth travel thereof from the storage position to the accessing position. In other words, the pusher arrangement 23″ helps the slider platform 12″ to operate smoothly when the actuation unit 22″ is activated.

More specifically, the pusher arrangement 23″ comprises a pusher member 231″ movably mounted on the mounting base 11″ to selectively push the slider platform 12″ moving from the storage position and the accessing position, and a gear unit 232″ operatively connecting actuating unit 22″ with the slider platform 12″, wherein the actuating cable 222″ has a first end connected to the actuator 221″ and a second end connected to the gear unit 232″ in such a manner that when the actuator 221″ is manually actuated by the user of the present invention, the actuating cable 222″ is also driven to pull the gear unit 232″ so as to rotate the gear unit 232″ for driving the pusher member 231″ to pivotally move to push the slider platform 12″ out of the drawer compartment 70″. In other words, the pusher member 231″ is adapted to disengage the magnetic attraction between the magnetic elements 2111″. Moreover, the pusher member 231″, which is pivotally coupled with the mounting base, has an arc-shaped pushing surface 2311″ to push the slider platform 12″ when the pusher member 231″ is driven to pivotally move by the actuator 221″ via the actuating cable 222″.

According to the second preferred embodiment of the present invention, the magnetic member 211″ comprises a plurality of magnetic elements 2111″ provided on the pusher member 231″ and the slider platform 12″ respectively, wherein when the slider platform 12″ is in the normal storage position, the magnetic elements 2111″ are aligned with each other so as to magnetically attract the slider platform 12″ to the mounting base 11″. In other words, when the magnetic engagement between the slider platform 12″ and the retention member 212″ ceases to exist, the slider platform 12″ is arranged to slide out of the drawer compartment 70″ so as to be accessed by the user of the present invention. Since the slider platform 12″ is inclinedly mounted with respective to horizontal, when the magnetic attractive force ceases to exist, the slider platform 12″, owning to its own weight, will slide out of the drawer compartment 70″ due to normal gravitational force.

Alternatively, the magnetic member 211″ comprises two or more first magnetic elements 2111″ spacedly provided at the mounting base and two or more second magnetic elements 2112″ spacedly provided at the slider platform 12″ to align with the first magnetic elements 2111″ respectively such that the slider platform 12″ is magnetically locked at the storage position when the second magnetic elements 2112″ are magnetically engaged with the first magnetic elements 2111″ respectively.

The pusher member 231″ assists sliding of the slider platform 12″ by pushing the slider platform 12″ out from the drawer compartment 70″. It is worth mentioning that the magnetic element 2111″ can be attached on the corresponding position of the drawer 60″, the container 90″ or the slider platform 12″ so that when the pusher member 231″ exerts a pushing force against the corresponding pusher object (i.e. the slider platform 12″, the container 90″ or the drawer 60″), the magnetic engagement of the magnetic member 211″ is broken to allow the slider platform 12″ sliding out of the drawer compartment 60″.

The gear unit 232″ comprises a bevel gear unit comprising a first and a second gear member 2321″, 2322″ engaging with each other, wherein the first gear member 2321″ is vertically supported by the docking frame 10″ and connected with the actuating cable 222″ while the second gear member 2322″ is horizontally supported by the docking frame 10″ via a gear shaft to connect with the pusher member 231″ while engaging with the first gear member 2321″. Thus, when the actuating cable 222″ is actuated (i.e. pulled by the actuator 221″), the first gear member 2321″ is pushed to rotate (about a horizontal axis) and drives the second gear 2322″ to rotate as well (about a vertical axis). The pusher member 231″ has one end connected with the second gear 2322″ in such a manner that when the second gears 2322″ is driven to rotate, the pusher member 231″ is also driven to move in a pivotal manner about the gear shaft so as to pivotally push the slider platform 12″ to slide out of the drawer compartment 60″.

Similar to the first preferred embodiment, the actuator 221″ comprises first and second actuation members 2211″, 2212″ pivotally connected with each other in such a manner that the first actuation member 2211″ is adapted to be depressed with respect to the second actuation member 2212″, wherein the driving end of the actuating cable 222″ is connected with the first actuation members 2211″ so that when the first actuation members 2211″ is depressed, the driving end of the actuating cable 222″ is pulled for pulling the driven end thereof so as to drive the first gear member 2321″ to rotate.

The pusher arrangement 23″ further comprises a resilient element 233″ mounted on the docking frame 10″ to normally exert a pulling force toward the pusher member 231″ for restoring the pusher member 231″ into its original position when it has pushed the slider platform 12″ to the accessing position.

Moreover, in order to further enhance the sliding movement of the slider platform 12″, according to the second preferred embodiment of the present invention, each of the slider tracks 111″ comprises a first and a second track members 1111″, 1112″ slidably engaging with each other, wherein then first track member 1111″ is affixed on the docking frame 10″ while the second track member 1112″ is affixed on the slider platform 12″ so as to allow the slider platform 12″ to slide between the storage position and the accessing position smoothly.

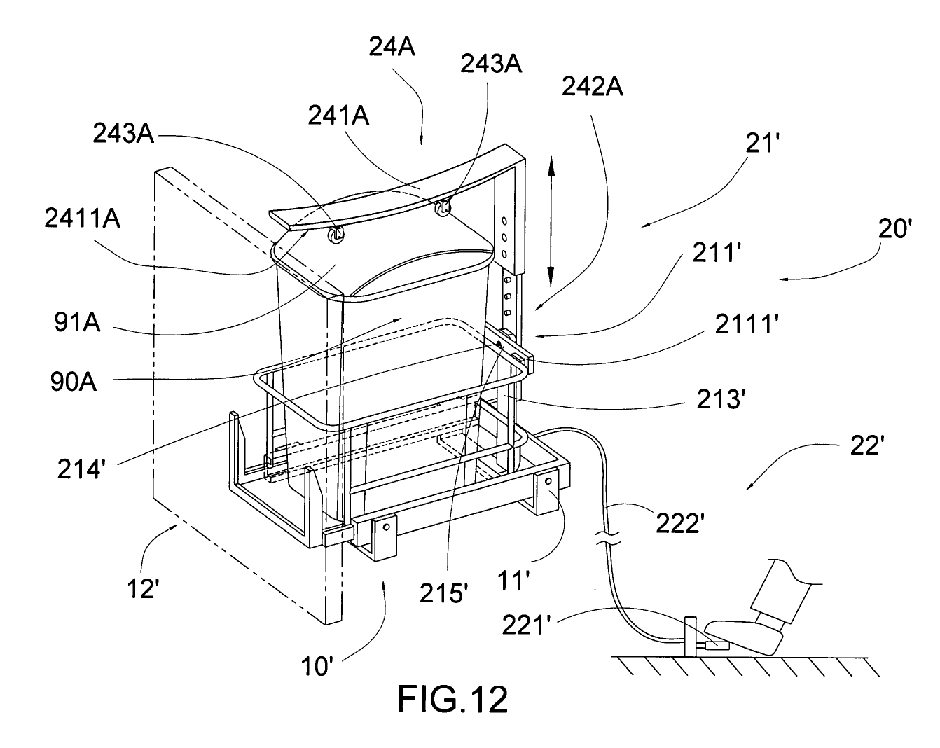

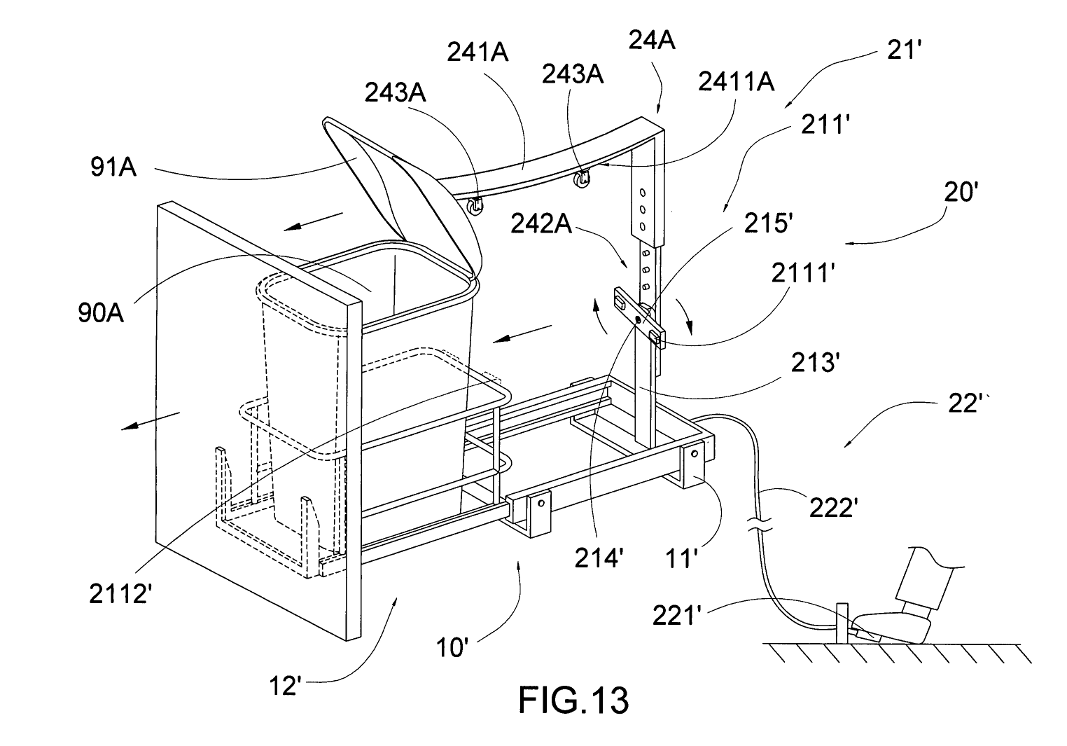

As shown in FIG. 12 and FIG. 13 of the drawings, the drawer releasing device may further comprise a cover control 24A for automatically controlling a pivot movement of a container cover 91A of a container 90A which sits on the slider platform 12′, wherein the cover control 24A comprises a guiding track 241A having a convex guiding surface 2411A, and a height adjustable support 242A suspendedly supported the guiding track 241A within the drawer compartment 70′ at a position above the container cover 91A, in such a manner that when the slider platform 12′ is slid at the slide-in storage position, the guiding track 91A is adapted for guiding the container cover 91A at the convex guiding surface 2411 A to close the container 90A, and when the slider platform 12′ is slid at the slide-out accessing position, the guiding track 241A is adapted for guiding the container cover 91A at the convex guiding surface 2411A to open the container 90A. A plurality of guiding rollers is suspendedly affixed on the convex guiding surface 2411A for smoothening the movement of the container cover 91A.

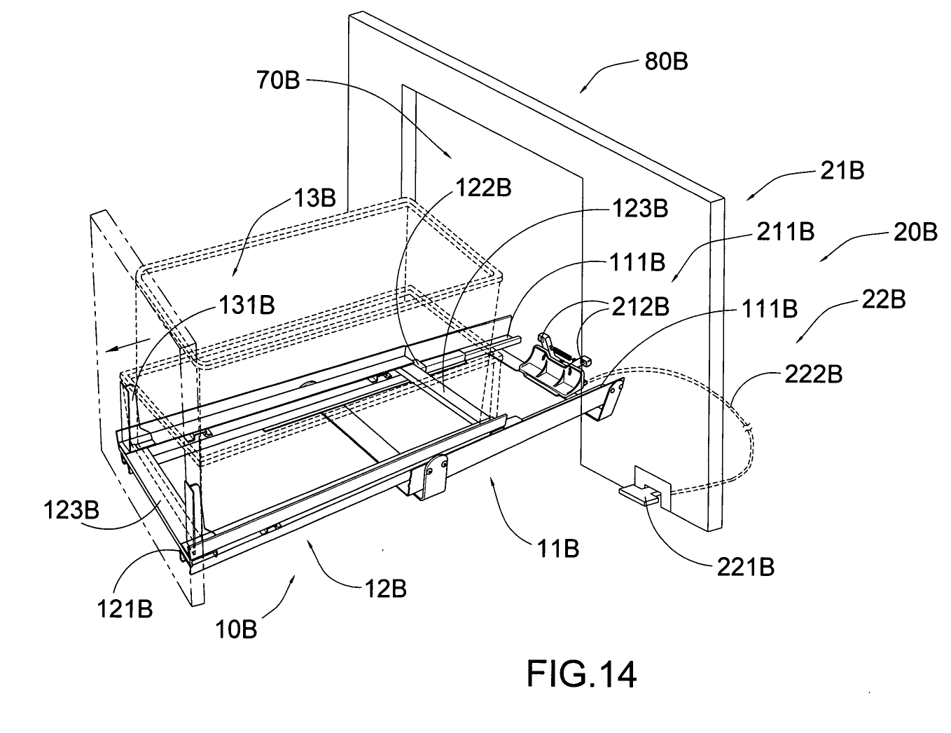

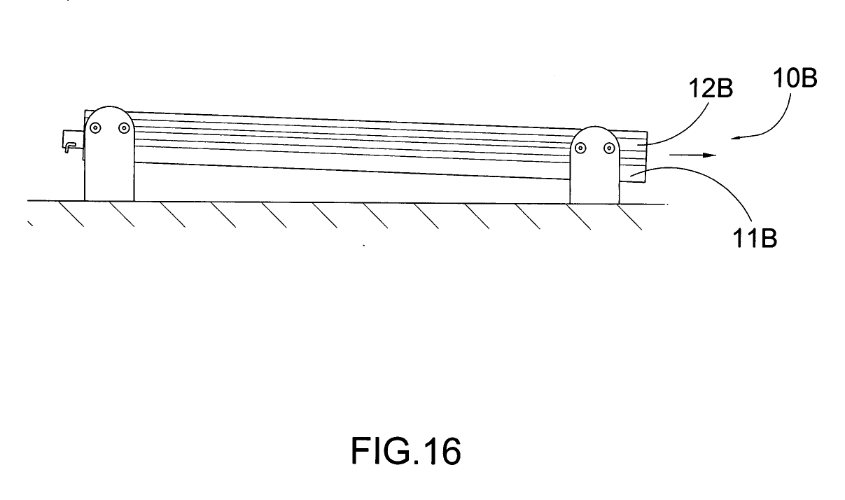

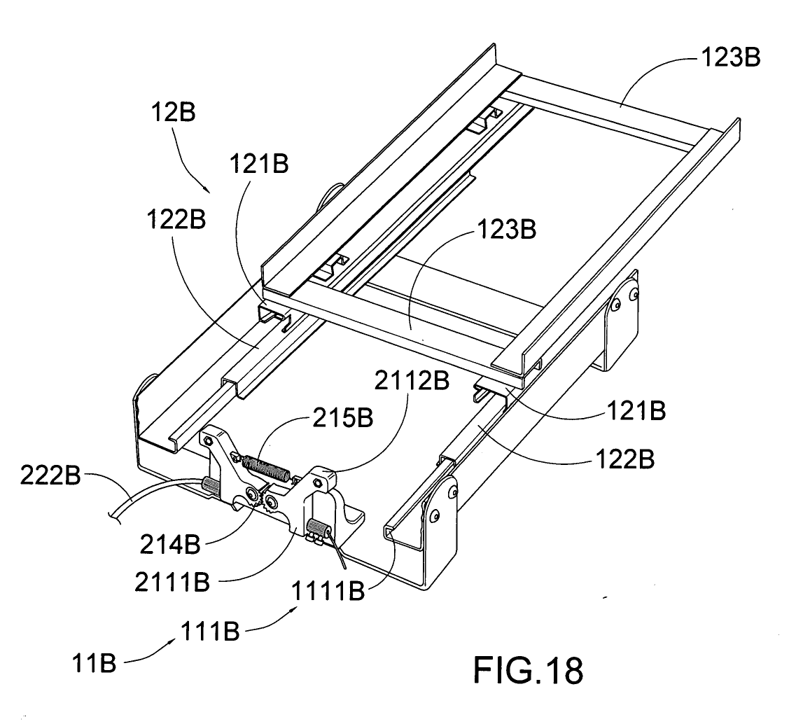

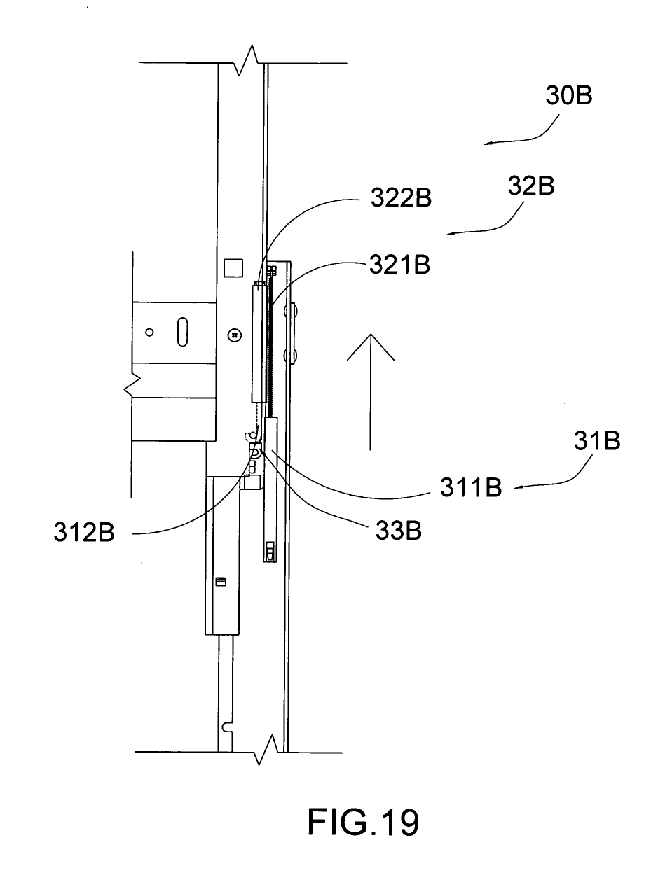

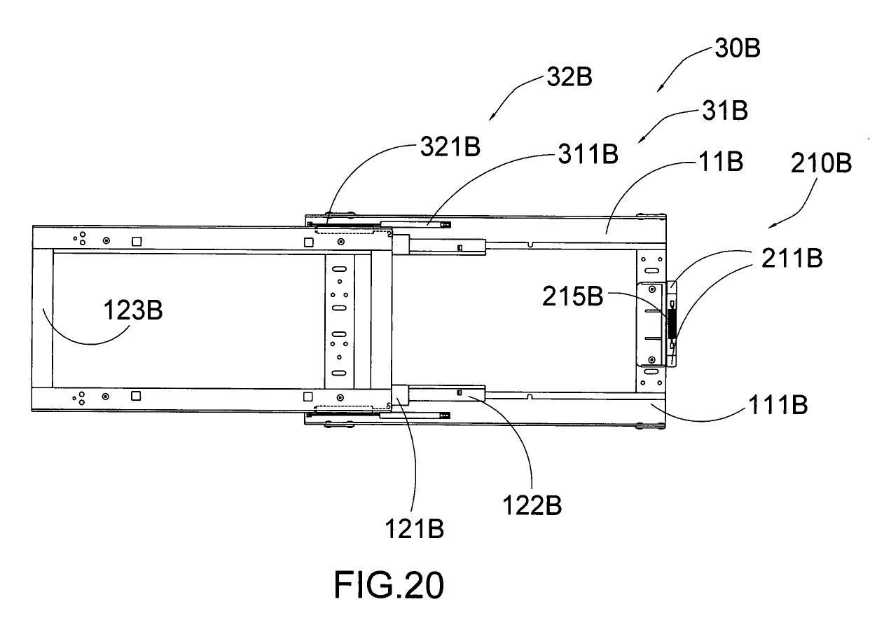

Referring to FIG. 14 to FIG. 21 of the drawings, a drawer releasing device for a drawer structure such as a cabinet 80B according to a fourth embodiment of the present invention is illustrated, in which the drawer releasing device comprises a docking frame 10B and an actuation unit 20B. The cabinet 80B, such as a conventional cabinet, has at least one drawer compartment 70B formed between two sidewalls and a bottom wall.

Thus, the docking frame 10B is adapted for supporting within the drawer compartment 70B of the cabinet 80B, and comprises a mounting base 11B and a slider platform 12B slidably and inclinedly mounted on the mounting base 11B to slide between a slide-in storage position that the slider platform 12B is disposed within the drawer compartment 70B, and a slide-out accessing position that the slider platform 12B is slid out of the drawer compartment 70B.

On the other hand, the actuation unit 20B comprises a locking unit 21B and a hand-free actuator 22B. The locking unit 21B is substantially mounted on the mounting base 11B to releasably engage with the slider platform 12B to lock up the slider platform 12B at the storage position. Therefore, when the hand-free actuator 22B is actuated, the locking unit 21B is unlocked to release the slider platform with respect to the mounting base 11B, so that an initial momentum of the slider platform 12B drives the slider platform 12B for automatically sliding out of the drawer compartment 70B in a hand-free manner.

More specifically, the mounting base 11B comprises two spaced apart sliding tracks 111B alignedly mounted on the bottom wall of the drawer compartment 70B and extending in an inclined manner that a rear end of each of the sliding tracks 111B is positioned higher than a front end of the sliding track 111B. The slider platform 12B comprises two spaced apart longitudinal members 121B slidably coupled with the respective sliding tracks 111B to inclinedly support the slider platform 12B on the mounting base 11B in a stably slidable manner, in such a manner that when the hand-free actuator 22B is actuated to unlock the locking unit 21B, the inclinedly supported slider platform 12B provides the initial momentum for automatically sliding out the of the drawer compartment 70B in the accessing position via the longitudinal members 121B.

Accordingly, the slider platform 12B further comprises front and rear transverse members 123B transversely and spacedly extended across the two longitudinal members 121B to form a quadrilateral cross sectional structure.

Accordingly, the two sliding tracks 111 B are formed along two side edges of the mounting base 11B respectively, such that a distance between the sliding tracks 111B can be maximized by the width of the mounting base 11B. Therefore, the slider platform 12B can be stably slid on the mounting base 11B to prevent the slider platform 12B from being flipped over during the sliding movement.

As mentioned above, the hand-free actuator 22B preferably comprises a foot actuation pedal 221B and an actuating cable 222B, which is extended from the locking unit 21B to the foot actuation pedal 221B, and is arranged in such a manner that when the foot actuation pedal 221B is operated to release an engagement of the locking unit 21B through the actuating cable 222B, the slider platform 12B is automatically sliding out of the drawer compartment 70B in the hand-free manner. In other words, the actuating cable 222B is operatively linked between the foot actuation pedal 221B and the locking unit 21B to actuate the locking unit 21B by means of a foot stepping force on the foot actuation pedal 221B.

In this preferred embodiment of the present invention, the sliding tracks 111B of the mounting base 11B are preferably interlocking with the two longitudinal members 121B of the slider platform 12B respectively, so as to ensure the slider platform 12B being alignedly slid with respect to the mounting base 11B. In particularly, the interlocking configuration of the slider platform 12B can prevent the slider platform 12B being flipped over when the slider platform 12B is slid from the slide-in storage position to the slide-out accessing position which is slid out of the drawer compartment 70B.

According to the preferred embodiment of the present invention, each of the longitudinal members 121B of the slider platform 12B may further comprises an auxiliary extending member 122B slidably interlocking with the sliding track 111B and the longitudinal member 121B for slidably extending a total length of the longitudinal member 121B. In other words, the longitudinal member 121B is interlocking with the sliding track 111B via the auxiliary extending member 122B.

As mentioned above, each of the auxiliary extending members 122B has a substantially quadrilateral cross section geographically matching a shape of elongated sliding groove 1111B for interlocking therewith, in which at least a first elastic element 1231B is movably provided between the auxiliary extending member 122B and the sliding groove 1111B of the sliding track 111B for securely interlocking therewith and facilitating a sliding motion of auxiliary extending member 122B with respect to the sliding track 111B.

The longitudinal members 121B preferably have a substantially inversed “U” shaped cross section in accordance with the cross sectional shape of the auxiliary extending member 122B, so that the longitudinal member 121B is adapted for slidably interlocking with the auxiliary extending member 122B to facilitate a sliding motion of the longitudinal member 121B with respect to both the auxiliary extending member 122B and the sliding track 111B in a speed control manner.

As a result, at least one second elastic member 1232B is preferably to be movably provided between the auxiliary extending member 122B and the longitudinal member 121B for securely and movably interlocking the longitudinal member 121B and the auxiliary extending member 122B, so that the total length of the longitudinal member 121B is increased via slidably interlocking with the auxiliary extending member 122B. In other words, the first and second elastic members 1231B, 1232B facilitate the sliding motion of the slider platform 12B and allow controlling the speed of sliding movement of the slider platform by the friction at the elastic members 1231B, 1232B.

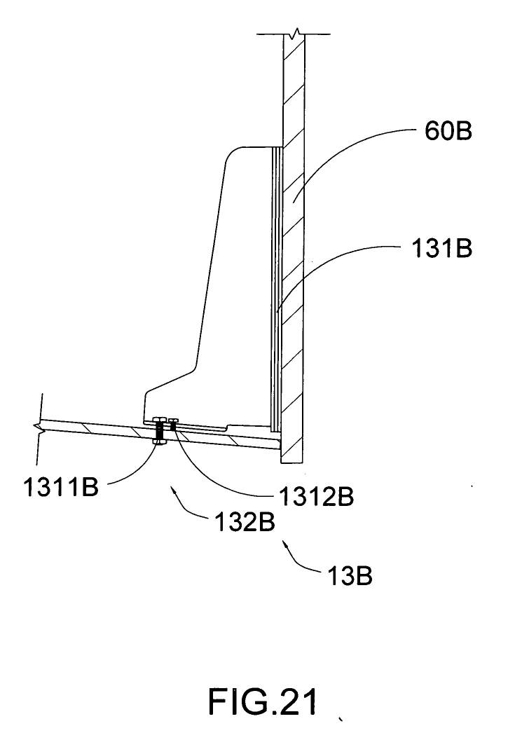

As best shown in FIG. 21 of the drawings, the docking frame 10B further comprises a drawer panel support 13B provided at a front side of the slider platform 12B for supporting a drawer panel 60B thereat. The drawer panel support 13B preferably comprises a panel frame 131B coupled with the front transverse member 123B for mounting to a rear side of the drawer panel 60B, and a panel inclination adjustor 132B adjustably mounting the panel frame 131B at the front side of the slider platform 12B for adjusting an inclination angle of the panel frame 131B until the drawer panel 60B is supported in a vertically upright manner.

In other words, the panel frame 131B of the drawer panel support 13B is upwardly extended from a front edge of the slider platform 12B, wherein the front panel 60B is arranged to be mounted on the front edge of the slider platform 12B, so as to cover the drawer compartment 70B when the slider platform 12B is slid thereinto at the storage position. In particularly, the panel frame 131B, having a L-shaped cross section, has a horizontal base portion mounted at the front transverse member 123B and a vertical head portion to support the front panel 60B in front of the slider platform 12B.

As will be readily appreciated by one skill in the art, the inclination adjustor 132B is provided in order to maximize the suitability of the drawer releasing device of the present invention with different kinds of cabinets 80 having different geographical structures. Therefore, the drawer panel support 13B can adjustably be mounted at the front edge of the slider platform 12B, so that the front panel 60B is capable of being mounted in a wide variety of orientations for fitting with different geographical structures of the cabinet 80B. Thus, the front panel 60B is able to be selectively adjusted in a vertical orientation to fittingly enclose the drawer compartment 70B when the slider platform 12B is slid thereinto at the storage position.

According to the preferred embodiment, the inclination adjustor 132B has at least a fixed slot 1311B provided at the base portion of the panel frame 131B to align with a fastening slot of the longitudinal members 121B such that the base portion of the panel frame 131B is coupled with the longitudinal members 121B by a first fastener, such as screw and nut, through the fixed slot 1311B. The inclination adjustor 132B further has an adjusting slot 1312B provided at the base portion of the panel frame 131B at a position adjacent to the fixed slot 1311B, preferably in front of the fixed slot 1311B, such that when a second fastener, such as a screw, is coupled at the adjusting slot 1312B, the head of the second fastener is biased against the top side of the front transverse member 123B to selectively adjust the inclination angle of the panel frame 131B with respect to the front transverse member 123B of the slider platform 12B. Accordingly, when the second fastener is rotated to press on the top side of the front transverse member 123B, the inclination angle of the panel frame 131B is increased. Therefore, the second fastener is kept rotating unit the head portion of the panel frame 131B is adjusted at the vertical orientation. In other words, the front panel 60B will be selectively adjusted in a vertical orientation in order to close the drawer compartment 70B. It is worth mentioning that when the orientation of the panel frame 131B is correctly adjusted, the first fastener can be tightened to secure the base portion of the panel frame 131B at the front transverse member 123B.

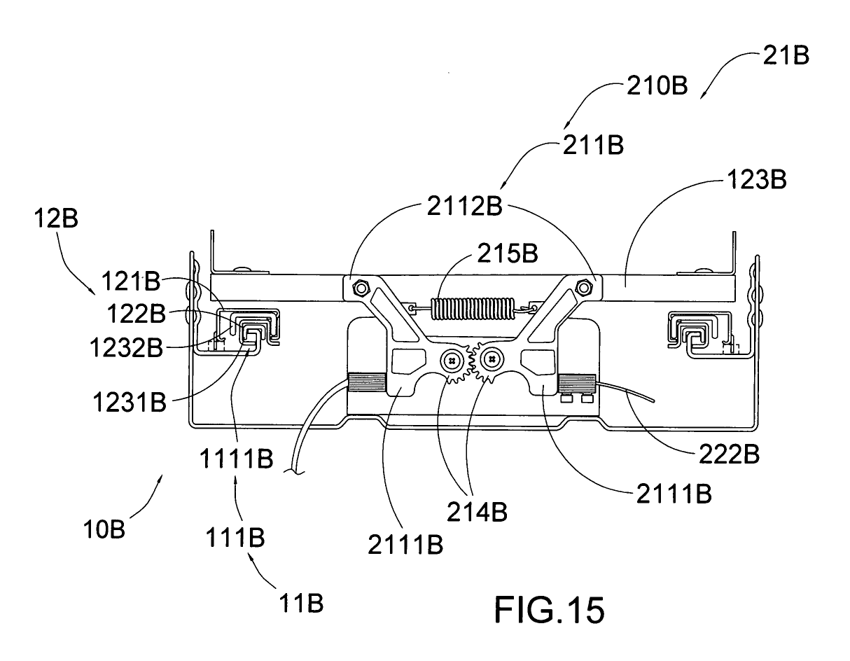

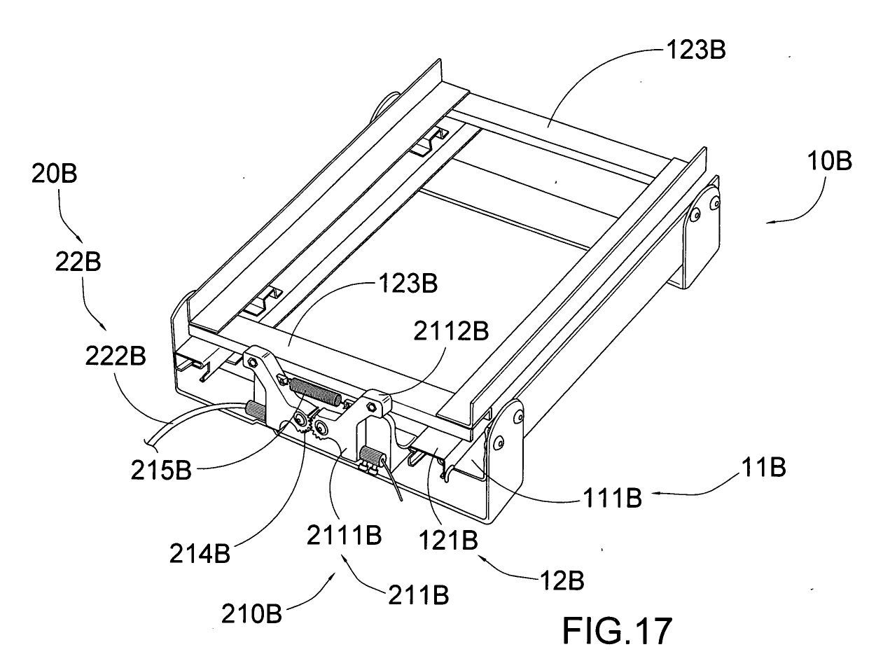

As best shown in FIGS. 15, 17, and, 18 of the drawings, the locking unit 21B preferably comprises a magnetic locker 210B provided at a rear side of the mounting base 11B for exerting a magnetic attractive force at a rear side of the slider platform 12B, so as to normally retain the slider platform 12B at the slide-in storage position.

According to the fourth preferred embodiment of the present invention, the magnetic locker 210B of the locking unit 21B preferably comprises two locking levers 211B, which are pivotally connected to each other at an inner end thereof. The locking levers 211B preferably have two driving ends 2111B engaging with the actuating cable 222B and two engaging outer ends 2112B to magnetically and securely engage to the slider platform 12B to retain the slider platform 12B at the storage position and arranged in such a manner that when the actuating cable 222B of the hand-free actuator 22B is driven by the foot actuating pedal 221B to move the driving ends 2111B of the locking levers 211B towards each other, the outer ends 2112B thereof are pivotally moved to release the slider platform 12B from the locking levers 211B, so as to unlock the slider platform 12B for freely sliding out of the drawer compartment 70B.

Moreover, two magnetic members 212B are preferably provided at the two outer ends 2112B of the locking levers 211B respectively to magnetically engage with the rear side of the slider platform 12B and arranged in such a manner that when the outer ends 2112B of the locking levers 211B are pivotally and outwardly moved via an actuation of the hand-free actuator 22B, the magnetic members 212B are misaligned with the rear side of the slider platform 12B for releasing the magnetic attractive force, so as to unlock the slider platform 12B for automatically sliding out the slider platform 12B at the accessing position thereof.

According to the conventional locking configuration, the drawer structure can be pulled out of the drawer compartment 70B when the conventional locking device is malfunctioned. In other words, once the conventional locking device is broken, the drawer will be permanently locked within the drawer compartment 70B.

According to the preferred embodiment, when the locking unit 21B is inoperative, the magnetic attractive force can also be released for allowing the slider platform 12B being manually slid out from the drawer compartment 70B when a pulling force is manually applied on the slider platform 12B. In other words, the user of the present invention is able to manually pull out the slider platform 12B from the storage position to the accessing position by exerting a sufficient amount of pulling force to overcome the magnetic force. However, it is important to realize that the magnetic force is such that the slider platform 12B is normally locked up and retained at the storage position if there is no extra pulling force exerted by the user of the present invention.

It is worth to mention that the driving end 2111B of one of the locking levers 211B is affixed to the actuating cable 222B while the driving end 2111B of the other locking lever 211B is slidably mounted to the actuating cable 222B, such that when the actuating cable 222B is pulled by the foot actuating pedal 221B to move the driving ends 2111B of the locking levers 211B towards each other, the engaging outer ends 2112B of the locking levers 211B are moved away from each other to release the slider platform 12B, so as to automatically slide out of the drawer compartment 70B via the initial momentum.

According to the preferred embodiment of the present invention, each of the locking levers 211B has a gear joint 214B formed between the driving end 2111B and the engaging outer end 2112B, wherein the gear joints 214B of the locking levers 211B are coupled with each other to synchronizely control the outer ends 2112B of the locking levers 211B engaging with the slider platform 12B in a coordinating manner.

Furthermore, the locking unit 21B further comprises a tension spring 215B, which has two ends coupling with the locking levers 211B respectively, wherein the tension spring 215B is adapted for applying a spring force thereat to retain the outer ends 2112B of the locking levers 211B aligning with the rear side of the slider platform 12B. In other words, when the actuating cable 222B is driving the driving end 2111B to pivotally move to a direction against the spring force, the engaging outer end 2112B of the locking levers 211B is misaligning with the rear side of the slider platform 12B to release magnetic force therebetween.

On the other hand, the foot actuating pedal 221B is extended out of the cabinet 80B by the actuating cable 222B so that the user of the present invention may release the engagement between the slider platform 12B and the magnetic members 212B at a distance through operating upon the foot actuating pedal 221B. Therefore, the foot actuating pedal 221B can be selectively located away from the docking frame 10B for operating the actuating unit 20B. More specifically, the actuating cable 222B, which is preferably embodied as a metal-made wire enclosed with durable and flexible plastic materials, has a driving end portion extended away from the drawer compartment 70B and connected with the foot actuating pedal 221B, and a driven end portion operatively connected with locking levers 211B in such a manner that when the foot actuating pedal 221B is operated, the driven end portion of the actuating cable 222B is pulled to exert an urging force towards the locking levers 211B for pivotally driving the locking levers 211B to disengage with the magnetic members 212B, so as to release the engagement between the slider platform 12B and the mounting base 11B.

According to the preferred embodiment of the present invention, the foot actuating pedal 221B is preferably to pivotally coupling to a pivot of the hand-free actuator 22B to form a seesaw like structure. The foot actuating pedal 221B has one end connecting to the actuating cable 222B, and the other end for being depressed for pivotally actuating the magnetic locker 210B of the locking unit 21B.

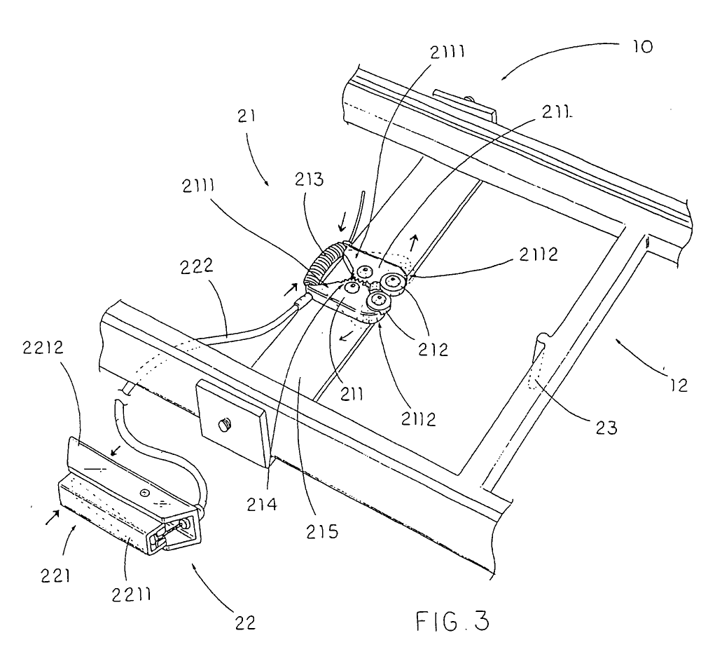

As best shown in FIG. 3 of the drawings, when the engagement between the slider platform 12B and the mounting base 11B is released, since the sliding tracks 111B are downwardly inclined towards the front side of the cabinet 80B, therefore, the sliding platform 12B will automatically due to natural gravitational force slide alone the sliding tracks 111B for moving from the storage position and the accessing position.

In order to enhance the automatic sliding motion of the slider platform 12B when the engagement between the slider platform 12B and the mounting base 11B has been released, the hand-free actuator 22B may further comprise a pair of restoring spring mounted at the sliding tracks 111B respectively for normally exerting an initial forward pushing force towards the slider platform 12B in such a manner that when the engagement between the slider platform 12B and the mounting base 11B is released, the restoring spring will push the slider platform 12B frontwardly towards the accessing position. In other words, the slider platform 12B is effectively pushed to slide from the storage position towards the accessing position in the above automatic manner.

In other words, the restoring spring can restore a predetermined energy, i.e. the compression spring force, when the slider platform 12B is pushed back to the storage position. Once the foot actuation pedal 221B is actuated, the restored energy will release to convert into the initial forward pushing force towards the slider platform 12B. Therefore, the initial forward pushing force will be restored every time when the slider platform 12B is pushed back to the storage position.

Referring to FIGS. 14, 19, and 20 of the drawings, the drawer releasing device may further comprise a braking system 30B for decelerating the slider platform 12B being slid from the slide-in storage position to the slide-out accessing position. The braking system 30B preferably comprises two brake actuators 31B outwardly extended from the longitudinal members 121B respectively and two braking units 32B provided at the front ends of the sliding tracks 111B respectively for applying an opposite urging force against a sliding force of the slider platform 12B when the brake actuators 31B engage with the braking units 32B respectively, so as to slow down the slider platform 12B before the slider platform 12B is slid at the slide-out accessing position. Thus, the slider platform 12B is able to securely slide out to the accessing position and stably support the bracket thereon for being accessed by the user, so as to enhance the security of the present invention.

Moreover, each of the braking units 32B preferably comprises a resilient element 321B and a hydraulic brake 322B, wherein the resilient elements 321B and the hydraulic brakes 322B are provided at the front end of the respective sliding tracks 111B. As a result, when the slider platform 12B is sliding toward the front end of the sliding tracks 111B to contact with the respective brake actuators 31B, the resilient element 321B and the hydraulic brake 322B are applying a resilient force and a hydraulic force respectively as the opposite urging force against the slider platform 12B.

More specifically, the resilient element 321B may be embodied as a resilient spring being mounted at the front end of the respective sliding track 111B, wherein a first brake actuator 311B is outwardly extended from the longitudinal members 121B of the slider platform 12B by one end, while engaging with the resilient spring of the resilient element 321B by the other end thereof. As a result, when the slider platform 12B is slid out of the drawer compartment 70B to actuate the first brake actuator 311B via the sliding force toward the front end of the sliding track 111B, the resilient spring of the resilient element 321B is applying the resilient force as the opposite urging force against the slider platform 12B, so as to decelerate a sliding speed thereof in the speed controlling manner.

Each of the hydraulic brakes 322B may be embodied as a pushing cylinder, as one of the example of the hydraulic brakes 322B, being mounted at the front end of the respective sliding track 111B, wherein a second brake actuator 312B is outwardly extended from each of the longitudinal members 121B of the slider platform 12B by one end, while slidably engaging within the pushing cylinder of the hydraulic brake 322B by the other end. Therefore, when the slider platform 12B is slid out of the drawer compartment 70B to actuate the second brake actuator 312B via the sliding force toward the front end of the sliding track 111B, the second brake actuator 312B is slidably pushing toward a front end of the pushing cylinder of the hydraulic brake 322B to generate the hydraulic force therefrom as the opposite urging force against the sliding force of the slider platform 12B, so as to decelerate the sliding speed thereof in the speed controlling manner.

It will be readily appreciated by one skilled in the art that the brake unit 30B may only comprises one of the resilient element 321B and the hydraulic brake 322B for providing the opposite urging force against the sliding force of the slider platform 12B. The resilient element 321B and the hydraulic brake 322B of the braking unit 32B are preferably provided at the same time for optimizing the performance of decelerating the slider platform 12B, so as to enhance the safety and the stability of the drawer releasing device of the present invention. The braking units 32B provided at respective sliding tracks 111B can be any other mechanisms for providing the opposite urging force against the sliding force toward the front end of the sliding tracks 111B. The resilient elements 321B and the hydraulic brake 322B are only illustrated as an example for decelerating the sliding speed of the slider platform 12B.

The operation and application of the present invention is as follows: the docking frame 10B is received in the drawer compartment 70B, wherein the drawer or any other container, such as a rubbish bin, is supported on the supporting frame of the slider platform 12B or the bracket. The hand-free actuator 22B is extended from the slider platform 12B to an exterior of the cabinet 80B, so that the user is able to actuate it at a distance. It is important to emphasis that foot actuating pedal 221B is preferably to be positioned on a ground surface so that the user may operate the foot actuating pedal 221B by his/her foot without using his/her hands.

According to the fourth preferred embodiment of the present invention, the braking system 30B may further comprises two brake pedals 33B provided at each of the braking units 32B to alignedly engage with the brake actuators 31B respectively when the slider platform 12B slides on the mounting base 11B of the docking frame 10B. The brake pedals 33B are preferably made of noise absorption material for reducing the noise being generated during the impact between the brake actuators 31B and the brake pedals 33B.

A method of actuating a drawer structure in a hand-free manner via a drawer releasing device according to the above preferred embodiment of the present invention is illustrated, wherein the method comprises the following steps.

(a) Support the mounting base 11B of the docking frame 10B within the drawer compartment 70B of the drawer at the position that the two spaced apart sliding tracks 111B of the mounting base 11B extending in the inclined manner.

(b) Inclinedly support the slider platform 12B of the docking frame 10B on the mounting base 11B in a slidably movable manner.

(c) Normally retain the slider platform 12B at the storage position by the locking unit 21B of the actuation unit 20B, which is mounted on the mounting base 11B to releasably engage with the slider platform 12B, so as to lock up the slider platform 12B at the storage position.

(d) Actuate the hand-free actuator 22B, which is located out of the drawer compartment 70B, to release the slider platform 12B from the locking unit 21B. The initial momentum of the slider platform 12B drives the slider platform 12B for automatically sliding out of the drawer compartment 70B in the hand-free manner.

In the step (b), the slider platform 12B is slidably coupling with the two spaced apart longitudinal members 121B of the slider platform 12B with the sliding tracks 111B of the mounting base 11B respectively. The longitudinal members 121B are preferably interlocking with the sliding tracks 111B to enhance a stabilization and smoothness of the slider platform 12B. The slider platform 12B is adapted to slide between the slide-in storage position that the slider platform 12B is disposed within the drawer compartment 70B and a slide-out accessing position that the slider platform 12B is slid out of the drawer compartment 70B.

Accordingly, the method may further comprises a step of restoring the initial forward pushing force when the slider platform 12B is slid back to the storage position, and a step of exerting an initial forward pushing force towards the slider platform 12B to automatically slide the slider platform 12B out of the drawer compartment 70B, when the locking unit 21B releases the slider platform 12B to slide out of the drawer compartment 70B.

The initial forward pushing force may be the initial momentum of the higher potential energy of the inclined sliding tracks 111B, and being exerted via converting the potential energy to the kinetic energy. In other words, the rear ends of the sliding tracks 111 higher than the front ends thereof restores the potential energy, and when the locking unit 21B is released the slider platform 12B, the potential energy is converted into the kinetic energy to provide the sliding force to the slider platform 12B for sliding out of the drawer compartment 70B at the accessing position.

The step (c) of the method further comprises a step of exerting the magnetic attractive force at the rear side of the slider platform 12B to normally retain the slider platform 12B at the slide-in storage position. As a result, when the magnetic attractive force is released via actuating the locking unit 21B, the slider platform 12B is unlocked for automatically sliding out of the drawer compartment in the hand-free manner.

According to the preferred embodiment of the present invention, the method may further comprises a step (e) of decelerating the slider platform 12B being slid from the slide-in storage position to the slide-out accessing position by the braking system 30B, as mentioned in the above fourth preferred embodiment.

As mentioned above, the step (e) may further comprises the following steps of (e.1) providing the two brake actuators 31B and the two braking units 32B engaging with the respective brake actuators 31B, and (e.2) applying the opposite urging force against the slider platform 12B.

The brake actuators 31B are preferably provided at the longitudinal members 121B respectively while the two braking units 32B are provided at the front ends of the sliding tracks 111B respectively to engage with the respective brake actuators 31B. Therefore, when the brake actuators 31B is actuated by the sliding force of the slider platform 12B to actuate the braking units 32, the braking units 32 generate the opposite urging force against the sliding force toward the front ends of the sliding tracks 111B, so as to decelerate the sliding speed of the slider platform 12B with respect to the sliding tracks 111B. The braking units 32B may comprises the resilient element 321B and/or the hydraulic brake 3228 as described in the above fourth preferred embodiment of the present invention.

In the step (d) of the method, a step of reducing the noise may further be provided, wherein the noise being generated during the compact between the brake actuators 31B and the braking units 32B may be reduced by providing two brake pedals 33B at the braking units 32B to alignedly engage with the brake actuators 31B respectively. Accordingly, when the slider platform 12B slides on the mounting base 11B, the brake actuators 31B impact with the brake pedals 33B, which is preferably made of noise absorption material, such as rubber, plastic, or the like, to reduce the noise thereof.

Accordingly, the actuation unit 20B preferably comprises the locking unit 21B to lock up the slider platform 12B at the storage position, and the hand-free actuator 22B being arranged in such a manner that when the hand-free actuator 22B is being actuated in the hand-free manner to release engagement between the locking unit 21B and the slider platform 12B, the slider platform 12B is automatically slid out of the drawer compartment 70B for being accessed.

It is worth to mention that the locking unit 21B may comprise the magnetic locker 210B comprising the two locking levers 211B and the two magnetic member 212B as described in the above preferred embodiment of the present invention. The hand-free actuator 22B preferably comprises the foot actuation pedal 221B and the actuating cable 222B being arranged as mentioned in the above fourth preferred embodiment of the present invention.

Therefore, a step of applying a foot stepping force on the foot actuation pedal 221B of the hand-free actuator 22B is preferably provided, wherein when a foot stepping force is applied on the foot actuation pedal 221B to depress thereof, the actuating cable 222B is being driven to transmitting the foot stepping force to the locking unit 21B, so as to release the engagement between the locking unit 21B and the slider platform 12B at the accessing position. As a result, the slider platform 12B is able to be actuated at a distance in the hand-free manner via the drawer releasing device of the present invention.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A drawer releasing device for a cabinet having a drawer compartment, comprising:
a docking frame, which is adapted for supporting within said drawer compartment of said drawer, comprising:
a mounting base which comprises two spaced apart sliding tracks extending in an inclined manner that a rear end of each of said sliding tracks is positioned higher than a front end of said sliding track; and
a slider platform which comprises two spaced apart longitudinal members slidably coupled with said sliding tracks respectively to inclinedly support said slider platform on said mounting base in a stably slidable manner, wherein said slider platform is adapted to slide between a slide-in storage position that said slider platform is disposed within said drawer compartment and a slide-out accessing position that said slider platform is slid out of said drawer compartment; and
an actuation unit which comprises a hand-free actuator positioned out of said drawer compartment and a locking unit which is operatively linked to said hand-free actuator and is mounted on said mounting base to releasably engage with said slider platform to lock up said slider platform at said storage position, wherein when said hand-free actuator is actuated, said locking unit is unlocked to release said slider platform with respect to said mounting base, an initial momentum of said slider platform drives said slider platform for automatically sliding out of said drawer compartment in a hand-free manner.

2. The drawer releasing device, as recited in claim 1, wherein said sliding tracks are interlocked with said longitudinal members respectively for ensuring said slider platform being alignedly slid with respect to said mounting base.

3. The drawer releasing device, as recited in claim 1, further comprising a braking system for decelerating said slider platform being slid from said slide-in storage position to said slide-out accessing position, wherein said braking system comprises two brake actuators outwardly extended from said longitudinal members respectively and two braking units provided at said front ends of said sliding tracks respectively for applying an opposite urging force against said slider platform when said brake actuators engage with said braking units respectively so as to slow down said slider platform before said slider platform is slid at said slide-out accessing position.

4. The drawer releasing device, as recited in claim 2, further comprising a braking system for decelerating said slider platform being slid from said slide-in storage position to said slide-out accessing position, wherein said braking system comprises two brake actuators outwardly extended from said longitudinal members respectively and two braking units provided at said front ends of said sliding tracks respectively for applying an opposite urging force against said slider platform when said brake actuators engage with said braking units respectively so as to slow down said slider platform before said slider platform is slid at said slide-out accessing position.

5. The drawer releasing device, as recited in claim 3, wherein each of said braking units comprises a resilient element supported at said front end of said respective sliding track for applying a resilient force as said opposite urging force against said slider platform when said respective brake actuator contacts with said resilient element.

6. The drawer releasing device, as recited in claim 4, wherein each of said braking units comprises a resilient element supported at said front end of said respective sliding track for applying a resilient force as said opposite urging force against said slider platform when said respective brake actuator contacts with said resilient element.

7. The drawer releasing device, as recited in claim 3, wherein each of said braking units comprises a hydraulic brake supported at said front end of said respective sliding track for applying a hydraulic force as said opposite urging force against said slider platform when said respective brake actuator contacts with said hydraulic brake.

8. The drawer releasing device, as recited in claim 4, wherein each of said braking units comprises a hydraulic brake supported at said front end of said respective sliding track for applying a hydraulic force as said opposite urging force against said slider platform when said respective brake actuator contacts with said hydraulic brake.

9. The drawer releasing device, as recited in claim 3, wherein each of said braking units comprises a resilient element and a hydraulic brake supported at said front end of said respective sliding track for applying a resilient force and a hydraulic force as said opposite urging force at the same time against said slider platform when said respective brake actuator contacts with said resilient element and said hydraulic brake.

10. The drawer releasing device, as recited in claim 4, wherein each of said braking units comprises a resilient element and a hydraulic brake supported at said front end of said respective sliding track for applying a resilient force and a hydraulic force as said opposite urging force at the same time against said slider platform when said respective brake actuator contacts with said resilient element and said hydraulic brake.

11. The drawer releasing device, as recited in claim 4, wherein said braking system further comprises two brake pedals provided at said braking units to alignedly engage with said brake actuators respectively when said slider platform slides on said mounting base, wherein said brake pedals are made of noise absorption material for reducing the noise being generated during the impact between said brake actuators and said brake pedals.

12. The drawer releasing device, as recited in claim 6, wherein said braking system further comprises two brake pedals provided at said braking units to alignedly engage with said brake actuators respectively when said slider platform slides on said mounting base, wherein said brake pedals are made of noise absorption material for reducing the noise being generated during the impact between said brake actuators and said brake pedals.

13. The drawer releasing device, as recited in claim 8, wherein said braking system further comprises two brake pedals provided at said braking units to alignedly engage with said brake actuators respectively when said slider platform slides on said mounting base, wherein said brake pedals are made of noise absorption material for reducing the noise being generated during the impact between said brake actuators and said brake pedals.

14. The drawer releasing device, as recited in claim 10, wherein said braking system further comprises two brake pedals provided at said braking units to alignedly engage with said brake actuators respectively when said slider platform slides on said mounting base, wherein said brake pedals are made of noise absorption material for reducing the noise being generated during the impact between said brake actuators and said brake pedals.

15. The drawer releasing device, as recited in claim 1, wherein said locking unit comprises a magnetic locker provided at said mounting base for exerting a magnetic attractive force at a rear side of said slider platform so as to normally retain said slider platform at said slide-in storage position.

16. The drawer releasing device, as recited in claim 14, wherein said locking unit comprises a magnetic locker provided at said mounting base for exerting a magnetic attractive force at a rear side of said slider platform so as to normally retain said slider platform at said slide-in storage position.

17. The drawer releasing device, as recited in claim 15, wherein said magnetic locker comprises two locking levers pivotally connecting at inner ends thereof, and two magnetic members provided at two outer ends of said locking levers respectively to magnetically engage with said rear side of said slider platform and arranged in such a manner that when said outer ends of said locking levers are pivotally and outwardly moved via an actuation of said hand-free actuator, said magnetic members are misaligned with said rear side of said slider platform for releasing said magnetic attractive force so as to unlock said slider platform at said slide-in storage position.

18. The drawer releasing device, as recited in claim 16, wherein said magnetic locker comprises two locking levers pivotally connecting at inner ends thereof, and two magnetic members provided at two outer ends of said locking levers respectively to magnetically engage with said rear side of said slider platform and arranged in such a manner that when said outer ends of said locking levers are pivotally and outwardly moved via an actuation of said hand-free actuator, said magnetic members are misaligned with said rear side of said slider platform for releasing said magnetic attractive force so as to unlock said slider platform at said slide-in storage position.

19. The drawer releasing device, as recited in claim 17, wherein said magnetic locker further comprises a tension spring having two ends coupling with said locking levers for applying a spring force thereat so as to retain said outer ends of said locking levers aligning with said rear side of said slider platform.

20. The drawer releasing device, as recited in claim 18, wherein said magnetic locker further comprises a tension spring having two ends coupling with said locking levers for applying a spring force thereat so as to retain said outer ends of said locking levers aligning with said rear side of said slider platform.

21. The drawer releasing device, as recited in claim 1, wherein said hand-free actuator comprises a foot actuation pedal and an actuating cable operatively linked between said foot actuation pedal and said locking unit to actuate said locking unit by means of a foot stepping force on said foot actuation pedal.

22. The drawer releasing device, as recited in claim 20, wherein said hand-free actuator comprises a foot actuation pedal and an actuating cable operatively linked between said foot actuation pedal and said locking unit to actuate said locking unit by means of a foot stepping force on said foot actuation pedal.

23. The drawer releasing device, as recited in claim 1, further comprising a drawer panel support provided at a front side of said slider platform for supporting a drawer panel thereat, wherein said drawer panel support comprises a panel frame adapted for mounting to a rear side of said drawer panel, and a panel inclination adjustor adjustably mounting said panel frame at said slider platform for adjustably an inclination angle of said panel frame until said drawer panel is supported in a vertically upright manner.

24. The drawer releasing device, as recited in claim 16, further comprising a drawer panel support provided at a front side of said slider platform for supporting a drawer panel thereat, wherein said drawer panel support comprises a panel frame adapted for mounting to a rear side of said drawer panel, and a panel inclination adjustor adjustably mounting said panel frame at said slider platform for adjustably an inclination angle of said panel frame until said drawer panel is supported in a vertically upright manner.

25. The drawer releasing device, as recited in claim 22, further comprising a drawer panel support provided at a front side of said slider platform for supporting a drawer panel thereat, wherein said drawer panel support comprises a panel frame adapted for mounting to a rear side of said drawer panel, and a panel inclination adjustor adjustably mounting said panel frame at said slider platform for adjustably an inclination angle of said panel frame until said drawer panel is supported in a vertically upright manner.

26. A method of actuating a drawer structure in a hand-free manner via a drawer releasing device, comprising the steps of:
(a) supporting a mounting base within a drawer compartment of said drawer at a position that two spaced apart sliding tracks of said mounting base extending in an inclined manner;
(b) inclinedly supporting a slider platform on said mounting base in a slidably movable manner by slidably coupling two spaced apart longitudinal members of said slider platform with said sliding tracks respectively to enhance a stabilization of said slider platform, wherein said slider platform is adapted to slide between a slide-in storage position that said slider platform is disposed within said drawer compartment and a slide-out accessing position that said slider platform is slid out of said drawer compartment;
(c) normally retaining said slider platform at said storage position by a locking unit which is mounted on said mounting base to releasably engage with said slider platform so as to lock up said slider platform at said storage position; and
(d) actuating a hand-free actuator, which is located out of said drawer compartment, to release said slider platform from said locking unit, wherein an initial momentum of said slider platform drives said slider platform for automatically sliding out of said drawer compartment in a hand-free manner.

27. The method, as recited in claim 26, further comprising the steps of exerting an initial forward pushing force towards said slider platform to slide said slider platform out of said drawer compartment; and restoring said initial forward pushing force when said slider platform is slid back to said storage position.

28. The method, as recited in claim 26, further comprising a step (e) of decelerating said slider platform being slid from said slide-in storage position to said slide-out accessing position by a braking system.

29. The method, as recited in claim 27, further comprising a step (e) of decelerating said slider platform being slid from said slide-in storage position to said slide-out accessing position by a braking system.

30. The method, as recited in claim 28, wherein the step (e) further comprises the steps of:
(e.1) providing two brake actuators at said longitudinal members respectively and two braking units at said front ends of said sliding tracks respectively; and
(e.2) applying an opposite urging force against said slider platform when said brake actuators engage with said braking units respectively so as to slow down said slider platform before said slider platform is slid at said slide-out accessing position.

31. The method, as recited in claim 29, wherein the step (e) further comprises the steps of:
(e.1) providing two brake actuators at said longitudinal members respectively and two braking units at said front ends of said sliding tracks respectively; and
(e.2) applying an opposite urging force against said slider platform when said brake actuators engage with said braking units respectively so as to slow down said slider platform before said slider platform is slid at said slide-out accessing position.

32. The method, as recited in claim 31, wherein each of said braking units comprises a resilient element supported at said front end of said respective sliding track for applying said opposite urging force against said slider platform when said respective brake actuator contacts with said resilient element.

33. The method, as recited in claim 31, wherein each of said braking units comprises a hydraulic brake supported at said front end of said respective sliding track for applying a hydraulic force as said opposite urging force against said slider platform when said respective brake actuator contacts with said hydraulic brake.

34. The method, as recited in claim 31, wherein each of said braking units comprises a resilient element and a hydraulic brake supported at said front end of said respective sliding track for applying a resilient force and a hydraulic force as said opposite urging force at the same time against said slider platform when said respective brake actuator contacts with said resilient element and said hydraulic brake.

35. The method, as recited in claim 31, wherein the step (d) further comprises a step of reducing the noise being generated during the compact between said brake actuators and said braking units by providing two brake pedals at said braking units to alignedly engage with said brake actuators respectively such that when said slider platform slides on said mounting base, said brake actuators impact with said brake pedals, wherein said brake pedals are made of noise absorption material.

36. The method, as recited in claim 34, wherein the step (d) further comprises a step of reducing the noise being generated during the compact between said brake actuators and said braking units by providing two brake pedals at said braking units to alignedly engage with said brake actuators respectively such that when said slider platform slides on said mounting base, said brake actuators impact with said brake pedals, wherein said brake pedals are made of noise absorption material.

37. The method, as recited in claim 26, wherein the step (c) further comprises a step of exerting a magnetic attractive force at a rear side of said slider platform to normally retain said slider platform at said slide-in storage position, such that when said magnetic attractive force is released, said slider platform is unlocked for automatically sliding out of said drawer compartment in a hand-free manner.

38. The method, as recited in claim 31, wherein the step (c) further comprises a step of exerting a magnetic attractive force at a rear side of said slider platform to normally retain said slider platform at said slide-in storage position, such that when said magnetic attractive force is released, said slider platform is unlocked for automatically sliding out of said drawer compartment in a hand-free manner.

39. The method, as recited in claim 36, wherein the step (c) further comprises a step of exerting a magnetic attractive force at a rear side of said slider platform to normally retain said slider platform at said slide-in storage position, such that when said magnetic attractive force is released, said slider platform is unlocked for automatically sliding out of said drawer compartment in a hand-free manner.

40. The method, as recited in claim 26, wherein the step (d) further comprises the steps of applying a foot stepping force on a foot actuation pedal of said hand-free actuator; and transmitting said foot stepping force to said locking unit via an actuating cable to actuate said locking unit.

41. The method, as recited in claim 31, wherein the step (d) further comprises the steps of applying a foot stepping force on a foot actuation pedal of said hand-free actuator; and transmitting said foot stepping force to said locking unit via an actuating cable to actuate said locking unit.

42. The method, as recited in claim 39, wherein the step (d) further comprises the steps of applying a foot stepping force on a foot actuation pedal of said hand-free actuator; and transmitting said foot stepping force to said locking unit via an actuating cable to actuate said locking unit.
